(19) United States
(12) Patent Application Publication
(10) Pub. No.: US 2022/0098034 A1
(43) Pub. Date: Mar. 31, 2022

(54) HETEROGENEOUS CATALYSTS FOR HYDROGEN GENERATION FROM FORMIC ACID

(71) Applicant: King Abdullah University of Science and Technology, Thuwal (SA)

(72) Inventors: Baraa WERGHI, Thuwal (SA); Jean-Marie BASSET, Thuwal (SA); Kuo-Wei HUANG, Thuwal (SA); Eva PUMP, Thuwal (SA); Anissa BENDJERIOUSEDJERARI, Thuwal (SA)

(21) Appl. No.: 17/414,440

(22) PCT Filed: Nov. 8, 2019
(86) PCT No.: PCT/IB2019/059622

§ 371 Date: Jun. 16, 2021

Related U.S. Application Data
(60) Provisional application No. 62/780,454, filed on Dec. 17, 2018.
(60) Provisional application No. 62/854,760, filed on May 30, 2019.

(51) Int. Cl. C01B 3/26; B01J 31/18; B01J 31/16; B01J 31/14; B01J 37/08; B01J 37/04; H01M 8/0612

(52) U.S. Cl. CPC C01B 3/26; B01J 31/189; B01J 31/1633; B01J 31/143; B01J 37/08; B01J 37/04; C01B 2203/1082; B01J 2531/0244; B01J 2531/821; C01B 2203/0277; C01B 2203/066; C01B 2203/1064; H01M 8/0618

(57) ABSTRACT

The invention relates to heterogeneous catalysts comprising an organo-ruthenium complex immobilized to an aluminum-modified inorganic oxide by a chemical bond between a tetra-coordinated aluminum atom on a surface of the aluminum-modified inorganic oxide and an amino or imino nitrogen of the organo-ruthenium complex, methods of preparing the heterogeneous catalysts including immobilizing the organo-ruthenium complex to a tetra-coordinated aluminum atom on a surface of an inorganic oxide by reacting an amino or imino nitrogen of the organo-ruthenium complex and an aluminum-modified inorganic oxide, followed by a defined heat treatment, as well as methods for producing hydrogen from formic acid using the heterogeneous catalysts.

### BACKGROUND

The challenge of the present century is to use alternative energy carriers to carbon-based materials such as the fossil fuels representing 85% of worldwide primary energy. The “ecologically driven” scenario described by the World Energy Council cannot be fulfilled by fossil fuels after 2030 with the present energy share. If nothing is done, coal will naturally peak about 2060, driving CO₂ well above 600 ppm by itself. Natural gas is a highly valuable primary energy, and must be preserved for the future.

The predictable shortage of fossil fuels must be managed. This is particularly true for transportation. For preserving the global economy and safety it is necessary to anticipate the peak oil and the CO₂ emissions by a major change in the transportation model. The Twenty-First Conference of Parties (COP 21) in Paris outlined a 20% reduction of greenhouse gas (GHG) emissions and a target of 20% of renewable energy for the transport sector. The importance of clean innovation in transport should lead to ˜95% GHG reduction in transport system in 2050.

Increasing the utilization of electric cars and transportations drive systems including hybrid, battery, and fuel cell electric vehicles will reduce the usage of petroleum and the emission of GHG by vehicles. Among the most advanced solutions is the use of electric cars working with fuel cells. But those electric cars need batteries which have a lot of drawbacks (e.g., weight and limited mileages). There is a need to complement electric car batteries systems.

The hydrogen fuel cell represents a new magic couple to replace the old magic couple (i.e., liquid hydrocarbons coupled with internal combustion engines). Hydrogen fuel cells transform chemical energy of H₂ in electricity and heat with high efficiency (>45%) and water as by-product without pollutant and noise. Hydrogen is a gas with no color and no odor; it is non corrosive, and very energetic (specific massic energy density): 1 kg H₂≈3 kg Gasoline≈2.4 kg CH₄. It is very light; at same weight: 1 L gasoline≈4.6 L H₂ at 700 bars. Conventional H₂ storage in high-pressure compressed gas cylinders or cryogenic liquid tanks is straightforward but suffers from excessive energy losses (H₂ compression, liquefaction, and boil-off) and low volumetric energy capacity.

A liquid source of hydrogen would overcome this drawback. Transforming hydrogen into formic acid (HCOOH) represents an attractive solution: Formic acid has a very high content of hydrogen and can be transported very easily. Formic acid can be very easily synthetized by reaction of CO₂ with hydrogen. Its potential application as a secondary fuel has been proposed and explored in direct FA fuel cells (DFAFCs). When formic acid is decomposed, the release of CO₂ is acceptable because the process consumes and delivers the same amount of CO₂. However, transforming formic acid back to hydrogen and CO₂ is a challenge. While this reaction can be catalyzed by available homogeneous catalysts, these catalysts are not suitable for use in electric vehicles because they cannot be recycled. There is a need for recyclable heterogeneous catalysts to generate hydrogen gas from formic acid for use in electric vehicles.

Research on catalytic formic acid decomposition has intensified rapidly during the past decade. Several homogeneous and heterogeneous catalysts have been investigated to maximize the dehydrogenation process. The homogenous system is by far the most investigated due to the high activity and selectivity in hydrogen generation. In contrast, the reported heterogeneous systems show poor catalytic performance. Yet, the heterogeneous form is the most interesting for practical applications. Heterogeneous catalysts with good activity and lifespans, with material stability under the reaction conditions required for an effective hydrogen production system, and with good selectivity for dehydrogenation of formic acid without production of noxious byproducts that may deactivate the catalyst (e.g., carbon monoxide) are needed.

### SUMMARY

In general, embodiments of the present disclosure describe a class of heterogeneous catalysts including an organo-ruthenium complex immobilized to an aluminum-modified inorganic oxide by a chemical bond between a tetra-coordinated aluminum atom on a surface of the aluminum-modified inorganic oxide and an amino or imino nitrogen of the organo-ruthenium complex, methods of preparing the heterogeneous catalysts, as well as methods of using the heterogeneous catalysts for dehydrogenating formic acid or formate to produce hydrogen gas and CO₂. The catalytically generated hydrogen gas can be utilized for chemical synthesis and fuel cells for powering buildings, cars, trucks, to portable electronic devices, backup power systems and grid-independent critical load functions.

Accordingly, embodiments of the present disclosure describe a heterogeneous catalyst for decomposition of formic acid into hydrogen gas and CO₂ comprising: an organo-ruthenium complex comprising an amino or imino group, wherein the nitrogen atom of the amino or imino group is immobilized to a tetra-coordinated aluminum atom grafted to a surface of an inorganic oxide. The heterogeneous catalyst can have the formula (M-O—)₂(X)Al—[N(RR′R″)Ruₘ], wherein M is a metal of the inorganic oxide support, X is a hydride or halide, each R and R′ are independently selected from a hydrogen atom or, a substituted or unsubstituted, alkyl, heteroalkyl, cycloalkyl, heterocyclyl, aryl, and heteroaryl group; R″ is selected from, a substituted or unsubstituted, alkyl, heteroalkyl, cycloalkyl, heterocyclyl, aryl, and heteroaryl group; and m is 1 or 2. As used herein, “metal of the inorganic oxide support” includes metalloids. The inorganic oxide support can be a porous material selected from the group consisting of silica, alumina, silica-alumina, a metallic surface, a Metal-Organic Framework (MOF) and a zeolite. For example, the inorganic oxide support M can be a fibrous silica nanosphere.

In any of the embodiments above, the organo-ruthenium complex is a ruthenium PN³ pincer-type complex having the structure of formula (I):

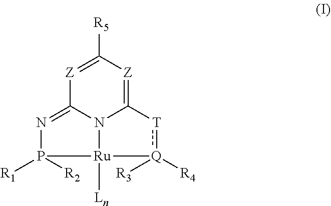

wherein: R₁ and R₂, are each independently, a substituted or unsubstituted, alkyl_{(C≤12)}, aryl_{(C≤12)}, or aralkyl_{(C≤12)} group; R₃ and R₄, if present, are each independently, a substituted or unsubstituted, alkyl_{(C≤12)}, aryl_{(C≤12)}, or aralkyl_{(C≤12)} group; R₅ is a substituted or unsubstituted alkyl_{(C≤12)}, aryl_{(C≤12)}, or aralkyl_{(C≤12)} group; each Z is independently CR₆, N or P; R₆ is a hydrogen atom or, a substituted or unsubstituted, alkyl_{(C≤12)}, aryl_{(C≤12)}, aralkyl_{(C≤12)}, amino, hydroxyl, or alkoxyl group; T is a N, NR₇, C, or CR₈; R₇ and R₈ are each independently a hydrogen or, a substituted or unsubstituted, alkyl_{(C≤12)}, aryl_{(C≤12)}, or aralkyl_{(C≤12)} group; L is a anionic ligand or a neutral ligand and n is 0, 1, or 2; Q is P or N; and optionally wherein T and Q, together, form a 5 or 6 membered heterocyclic ring; wherein the heterocyclic ring can optionally be substituted with one or more heteroatoms and or one or more sites of the heterocyclic ring are substituted with one or more, substituted or unsubstituted, alkyl_{(C≤12)}, aryl_{(C≤12)}, or aralkyl_{(C≤12)} groups, and optionally wherein the heterocyclic ring can have a fused ring attached thereto, provided when T and Q form a 5 or 6 membered heterocyclic ring, one or both of R₃ and/or R₄ are not present; and [symbol] designates a single bond or a double bond. For example, wherein T can be NH, Q can be P, R₁, R₂, R₃ and R₄ can each be a t-butyl group, X can be a hydrogen atom, L can be carbon monoxide, and n can be 1. In another example, T can be CH₂ and Q can be N.

In alternative embodiments of the heterogeneous catalyst above, the organo-ruthenium complex can be a bidentate ruthenium N,N′-diimine ligand complex according to formula (II)

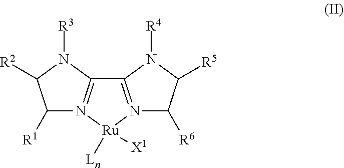

wherein: R¹, R², R³, R⁴, R⁵, and R⁶ are each independently selected from hydrogen, substituted or unsubstituted alkyl, and substituted or unsubstituted aryl; X¹ is a halide, a hydride, or a formate ion; L is a neutral ligand or an anionic ligand, and n is 0, 1, or 2.

In any of the embodiments above, the tetra-coordinated aluminum is grafted to the surface of the inorganic oxide support by a process comprising reacting a dehydroxylated inorganic oxide support with diisobutyl aluminum hydride to form a bipodal and tetrahedral isobutyl-aluminum complex, and heating the support to form a bipodal and tetrahedral hydride-aluminum complex.

Embodiments of the present disclosure further describe methods of making a heterogeneous catalyst for decomposition of formic acid into hydrogen gas and CO₂ comprising: providing an inorganic oxide support comprising at least one bipodal and tetrahedral aluminum atom on an accessible surface; immobilizing an organo-ruthenium complex comprising an accessible amino or imino nitrogen atom by forming a chemical bond between the accessible amino or imino nitrogen atom and the bipodal and tetrahedral aluminum atom; and heating the immobilized organo-ruthenium complex at a temperature sufficient to stabilize the chemical bond. The method can comprise grafting an aluminum alkyl precursor to a surface of a dehydroxylated inorganic oxide support to form an aluminum alkyl-modified support; and heating the aluminum alkyl-modified support to form an accessible bipodal and tetrahedral aluminum atom. The aluminum alkyl precursor can be di-isobutyl aluminum, di-isobutyl aluminum hydride, or di-isobutyl aluminum halide. Any of the embodiments above can include dehydroxylating the inorganic oxide support to achieve a surface hydroxyl density of about 0.1 to about 2 OH/nm². The inorganic oxide support can be a porous material selected from the group consisting of silica, alumina, silica-alumina, a metallic surface, a MOF and a zeolite. The inorganic oxide support can be a fibrous silica nanosphere, such as KAUST Catalyst Center (KCC)-1.

In any of the methods above, the organo-ruthenium complex can be a ruthenium PN³ pincer-type complex having the structure of formula (I):

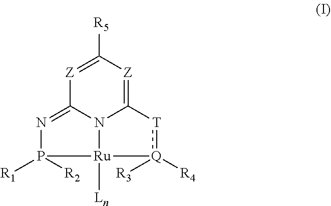

wherein: R₁ and R₂, are each independently, a substituted or unsubstituted, alkyl_{(C≤12)}, aryl_{(C≤12)}, or aralkyl_{(C≤12)} group; R₃ and R₄, if present, are each independently, a substituted or unsubstituted, alkyl_{(C≤12)}, aryl_{(C≤12)}, or aralkyl_{(C≤12)} group; R₅ is, a substituted or unsubstituted, alkyl_{(C≤12)}, aryl_{(C≤12)}, or aralkyl_{(C≤12)} group; each Z is independently CR₆, N or P; R₆ is a hydrogen atom or, a substituted or unsubstituted, alkyl_{(C≤12)}, aryl_{(C≤12)}, aralkyl_{(C≤12)}, amino, hydroxyl, or alkoxyl group; T is a N, NR₇, C, or CR₈; R₇ and R₈ are each independently a hydrogen, a substituted or unsubstituted, alkyl_{(C≤12)}, aryl_{(C≤12)}, or aralkyl_{(C≤12)} group; L is a anionic ligand or a neutral ligand and n is 0, 1, or 2; Q is P or N; and optionally wherein T and Q, together, form a 5 or 6 membered heterocyclic ring; wherein the heterocyclic ring can optionally be substituted with one or more heteroatoms and or one or more sites of the heterocyclic ring are substituted with one or more, substituted or unsubstituted, alkyl_{(C≤12)}, aryl_{(C≤12)}, or aralkyl_{(C≤12)} groups, and optionally wherein the heterocyclic ring can have a fused ring attached thereto, provided when T and Q form a 5 or 6 membered heterocyclic ring, one or both of R₃ and/or R₄ are not present; and [symbol] designates a single bond or a double bond. For example, T can be NH, Q can be P, R₁, R₂, R₃ and R₄ can each be a t-butyl group, X can be a hydrogen atom, L can be carbon monoxide, and n can be 1. In some cases, T can be CH₂ and Q is N.

In alternative embodiments of the method above, the organo-ruthenium complex can be a bidentate ruthenium N,N′-diimine ligand complex according to formula (II)

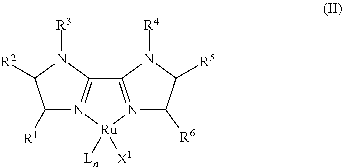

wherein: R¹, R², R³, R⁴, R⁵, and R⁶ can each independently be selected from hydrogen, substituted or unsubstituted alkyl, and substituted or unsubstituted aryl; X¹ can be a halide, a hydride, or a formate ion; L can be a neutral ligand or an anionic ligand, and n can be 0, 1, or 2.

Another embodiment of the present disclosure is a method of generating electricity comprising: (1) contacting formic acid, formate or a mixture thereof with a heterogeneous catalyst comprising an organo-ruthenium complex comprising an amino or imino group, wherein the nitrogen atom of the amino or imino group is immobilized to a tetra-coordinated aluminum atom grafted to a surface of an inorganic oxide to form hydrogen gas and CO₂; (2) delivering the hydrogen gas to a fuel cell; and (3) oxidizing the hydrogen gas in the fuel cell to generate electricity. The heterogeneous catalyst can be selected from any of the embodiments above.

### BRIEF DESCRIPTION OF DRAWINGS

This written disclosure describes illustrative embodiments that are non-limiting and non-exhaustive. The patent or application file contains at least one drawing executed in color. Copies of this patent or patent application publication with color drawing(s) will be provided by the Office upon request and payment of the necessary fee. In the drawings, which are not necessarily drawn to scale, like numerals describe substantially similar components throughout the several views. Like numerals having different letter suffixes represent different instances of substantially similar components. The drawings illustrate generally, by way of example, but not by way of limitation, various embodiments discussed in the present document.

Reference is made to illustrative embodiments that are depicted in the figures, in which:

FIG. 1 illustrates a heterogeneous catalyst according to one or more embodiments of the present disclosure.

FIG. 2 is a method for synthesizing a heterogeneous catalyst including an organo-ruthenium complex immobilized to an aluminum-modified inorganic oxide, according to one or more embodiments of the present disclosure.

FIG. 3 is a method for generating electricity including contacting formic acid or formate with a heterogeneous catalyst including an organo-ruthenium complex immobilized to an aluminum-modified inorganic oxide to generate hydrogen gas and CO₂, according to one or more embodiments of the present disclosure.

FIG. 4 shows the reaction scheme for synthesis of a Al-modified silica support according to one or more embodiments of the present disclosure. Insert shows bright field-Transmission Electronic Microscopy (BF-TEM) analysis of the dehydroxylated mesoporous fibrous silica nanosphere support (KCC-1700), according to one or more embodiments of the present disclosure.

FIG. 5 shows the reaction scheme for immobilization of Ru—PN³P complex onto Al—H modified silica support, according to one or more embodiments of the present disclosure.

FIG. 6 illustrates an experimental set-up for the synthesis of heterogeneous catalysts according to one or more embodiments of the present invention. As shown, an Al—H modified support (1) is introduced to one side of a double Schlenk, and 50 mg of homogeneous catalyst [Ru—H(PN³P)(CO)] is introduced in the other side in solvent (10 ml dry and degassed toluene).

FIGS. 7A-E shows the synthesis of catalyst (3) according to one or more embodiments of the present disclosure. (A) illustrates transfer of the solubilized homogeneous catalyst [Ru—H(PN³P)(CO)] to the support side of the double Schlenk in liquid nitrogen; (B) illustrates wash out of un-immobilized catalyst using toluene; (C) illustrates removal of remaining toluene under dynamic vacuum; (D) is a photograph of a light yellow powder collected from the double Schlenk; and (E) illustrates thermal treatment of the dried catalyst at 100° C. under dynamic vacuum.

FIG. 8 is the IR spectra in the 4000-1400 cm⁻¹ region at 25° C. of support (1), a Al—H modified silica oxide support according to one or more embodiments of the present disclosure, catalyst (2) according to one or more embodiments of the present disclosure, and catalyst (3) according to one or more embodiments of the present disclosure, which was generated after heating catalyst (2) at 100° C. under dynamic vacuum.

FIG. 9 shows the proton solid-state NMR spectrum of catalyst (3) according to one or more embodiments of the present disclosure (upper) and catalyst (2) according to one or more embodiments of the present disclosure (lower) each displaying five clear signals.

FIG. 10 shows the ¹³C solid-state NMR spectrum of catalyst (3) according to one or more embodiments of the present disclosure (upper) and catalyst (2) according to one or more embodiments of the present disclosure (lower). Solvent peaks are identified by asterisks.

FIG. 11 shows the ¹⁵N solid-state NMR spectrum of catalyst (3) according to one or more embodiments of the present disclosure (upper) and catalyst (2) according to one or more embodiments of the present disclosure (lower).

FIG. 12 shows the ³¹P solid-state NMR spectrum of catalyst (3) according to one or more embodiments of the present disclosure (upper) and catalyst (2) according to one or more embodiments of the present disclosure (lower). Solvent peaks are identified by asterisks.

FIG. 13 shows, low-mag (upper) and high-mag (lower), left to right, bright field-Transmission Electronic Microscopy (BF-TEM) image, elemental maps determined by STEM-EDS spectrum imaging for Al (blue), Ru (yellow), superimposed Al and Ru elemental maps, and superimposed Ru elemental map and BF-TEM image of an immobilized catalyst according to one or more embodiments of the present disclosure.

FIGS. 14(A-C) shows X-Ray photoelectron spectra characterizing (A) homogeneous catalyst (i.e., un-immobilized [Ru—H(PN³P)(CO)]), (B) immobilized catalyst (2) according to one or more embodiments of the present disclosure, and (C) immobilized catalyst (3) according to one or more embodiments of the present disclosure (catalyst (2) after thermal treatment).

FIG. 15 shows the Discrete Fourier Transform (DFT)-optimized geometry of an immobilized catalyst, according to one or more embodiments of the present disclosure. The results show a more stable structure Al coordination with E=(−23.8) kcal/mol for the lewis acid (right), which exhibits elongation of the Al—N bond (2.14 Å), whereas the lewis base E=(+4.1) kcal/mol and an Al—N bond length of (1.99 Å) (left).

FIG. 16 is an illustration of a two-necked round flask for formic acid decomposition experiments, according to one or more embodiments of the present disclosure.

FIG. 17 shows the results of four catalytic runs of formic acid decomposition using catalyst (2) according to one or more embodiments of the present disclosure, under batch conditions.

FIG. 18 are photographs showing leaching of the catalyst into the liquid phase when using catalyst (2) according to one or more embodiments of the present disclosure.

FIG. 19 shows the results of six catalytic cycles of formic acid decomposition using catalyst (3), according to one or more embodiments of the present disclosure, under batch conditions.

FIGS. 20(A-B) shows the results of continuous catalytic formic acid decomposition experiment (A), repeated results shown in (B) using catalyst (3) according to one or more embodiments of the present disclosure.

FIG. 21 is a photograph of the catalyst (3), according to one or more embodiments of the present disclosure, showing there was no leaching of the metal into the liquid phase.

### DETAILED DESCRIPTION

Embodiments of the present disclosure describe a class of heterogeneous catalysts including an organo-ruthenium complex immobilized to an aluminum-modified inorganic oxide by a chemical bond between a tetra-coordinated aluminum atom on a surface of the aluminum-modified inorganic oxide and an amino or imino nitrogen of the organo-ruthenium complex. Heterogeneous catalysts described herein can exhibit high catalytic activity for transforming formic acid (or formate) into hydrogen and CO₂ under moderate conditions and an improved lifetime relative to other catalysts. For example, a heterogeneous catalyst according to the present disclosure can catalyze decomposition of formic acid at room temperature with a Turnover Frequency (TOF) greater than 47,000/h and a Turnover Number (TON) greater than 130,000. Heterogeneous catalysts described herein show superior recyclability without leaching or substantial loss of activity. For example, a heterogeneous catalyst according to the present disclosure can be recycled up to 50 times, up to 75 times, or up to 100 times. A heterogeneous catalyst described herein can produce hydrogen gas from formic acid (or formate) without producing either noxious byproducts or byproducts that will deactivate the catalyst. For example, a heterogeneous catalyst of the present disclosure can selectively generate hydrogen gas from formic acid without producing carbon monoxide. The stability, recyclability, and rapid reaction rate under moderate conditions of the heterogeneous catalysts described herein facilitate efficient hydrogen production for fuel cells powering vehicles, portable electronic devices, buildings, backup power systems, data centers, telecommunications towers, hospitals, and emergency response systems.

### Definitions

The terms recited below have been defined as described below. All other terms and phrases in this disclosure shall be construed according to their ordinary meaning as understood by one of skill in the art.

As used herein, “about” or “approximately,” when used in connection with a numerical variable, generally refers to the value of the variable and to all values of the variable that are within the experimental error (e.g., within the 95% confidence interval for the mean) or within ±10% of the indicated value, whichever is greater.

As used herein, “heating” refers to increasing a temperature. For example, heating may refer to exposing or subjecting any environment, apparatus, object, material, etc. to a temperature that is greater than a current or previous temperature. In some cases, the current or previous temperature is the temperature of one or more of the environment, apparatus, object, material, etc.

As used herein, “heterogeneous catalysis” refers to a type of catalysis in which the catalyst occupies a different phase from the reactants and products.

As used herein, “homogeneous catalysis” refers to a type of catalysis in which the catalyst, reactant and products occupy the same phase.

The “turn over frequency” or “TOF”, as used herein, means the total number of moles transformed into the desired product by one mole of active site per hour.

The “turn over number” or “TON”, as used herein, means the number of moles of substrate that a mole of catalyst can convert before becoming inactivated.

When used in the context of a chemical group, “hydrogen” means —H; “hydroxy” means —OH; “oxo” means ═O; “halo” means independently —F, —Cl, —Br or —I; “hydroxyamino” means —NHOH; “nitro” means —NO₂; “cyan” means —CN; “isocyanate” means —N═C═O; “azido” means —N₃; in a monovalent context “phosphate” means —OP(O)(OH)₂ or a deprotonated form thereof; in a divalent context “phosphate” means —OP(O)(OH)O— or a deprotonated form thereof; “mercapto” means —SH; “thio” means S; “thioether” means ═S—; “sulfonamido” means —NHS(O)₂— (see below for definitions of groups containing the term sulfonamido, e.g., alkylsulfonamido); “sulfonyl” means —S(O)₂— (see below for definitions of groups containing the term sulfonyl, e.g., alkylsulfonyl); and “sulfinyl” means —S(O)— (see below for definitions of groups containing the term sulfinyl, e.g., alkylsulfinyl).

In the context of chemical formulas, the symbol “-” means a single bond, “═” means a double bond. The symbol “ [symbol] ” represents a single bond or a double bond. The symbol “≡Si—” means a surface silicon atom on a SiO₂ support.

For the groups and classes below, the following parenthetical subscripts further define the group/class as follows: “(Cn)” defines the exact number (n) of carbon atoms in the group/class. “(C≤n)” defines the maximum number (n) of carbon atoms that can be in the group/class, with the minimum number as small as possible for the group in question, e.g., it is understood that the minimum number of carbon atoms in the group “alkenyl_{(C≤8)}” or the class “alkene_{(C≤8)}” is two. For example, “alkoxy(co)” designates those alkoxy groups having from 1 to 10 carbon atoms (e.g., 1, 2, 3, 4, 5, 6, 7, 8, 9, or 10, or any range derivable therein (e.g., 3 to 10 carbon atoms). (Cn-n′) defines both the minimum (n) and maximum number (n′) of carbon atoms in the group. Similarly, “alkyl_{(C2-C10)}” designates those alkyl groups having from 2 to 10 carbon atoms (e.g., 2, 3, 4, 5, 6, 7, 8, 9, or 10, or any range derivable therein (e.g., 3 to 10 carbon atoms)).

As used herein, “substituted” refers to all permissible substituents of the compounds described herein. In the broadest sense, the permissible substituents include acyclic and cyclic, branched and unbranched, carbocyclic and heterocyclic, aromatic and nonaromatic substituents of organic compounds. Non-limiting examples of substituents include halogens, hydroxyl groups, or any other organic groupings containing any number of carbon atoms, preferably 1-14 carbon atoms, and optionally include one or more heteroatoms such as oxygen, sulfur, or nitrogen grouping in linear, branched, or cyclic structural formats. Representative substituents include alkyl, substituted alkyl, alkenyl, substituted alkenyl, alkynyl, substituted alkynyl, phenyl, substituted phenyl, aryl, substituted aryl, heteroaryl, substituted heteroaryl, halo, hydroxyl, alkoxy, substituted alkoxy, phenoxy, substituted phenoxy, aroxy, substituted aroxy, alkylthio, substituted alkylthio, phenylthio, substituted phenylthio, arylthio, substituted arylthio, cyano, isocyano, substituted isocyano, carbonyl, substituted carbonyl, carboxyl, substituted carboxyl, amino, substituted amino, amido, substituted amido, sulfonyl, substituted sulfonyl, sulfonic acid, phosphoryl, substituted phosphoryl, phosphonyl, substituted phosphonyl, polyaryl, substituted polyaryl, C₃-C₂₀ cyclic, substituted C₃-C₂₀ cyclic, heterocyclic, substituted heterocyclic, amino acid, peptide, and polypeptide groups. As discussed herein, heteroatoms such as nitrogen may have hydrogen substituents and/or any permissible substituents of organic compounds described herein which satisfy the valences of the heteroatoms. It is understood that “substitution” or “substituted” includes the implicit proviso that such substitution is in accordance with permitted valence of the substituted atom and the substituent, and that the substitution results in a stable compound, i.e., a compound that does not spontaneously undergo transformation such as by rearrangement, cyclization, elimination, etc.

As used herein, “heteroatom” means an atom of any element other than carbon or hydrogen. Preferred heteroatoms are boron, nitrogen, oxygen, phosphorus, sulfur, and selenium. Other heteroatoms include silicon and arsenic.

As used herein, the term “halide” designates —F, —Cl, —Br, or —I.

The term “aliphatic” when used without the “substituted” modifier signifies that the compound/group so modified is an acyclic or cyclic, but non-aromatic hydrocarbon compound or group. In aliphatic compounds/groups, the carbon atoms can be joined together in straight chains, branched chains, or non-aromatic rings (alicyclic). Aliphatic compounds/groups can be saturated, that is joined by single bonds (alkanes/alkyl), or unsaturated, with one or more double bonds (alkenes/alkenyl) or with one or more triple bonds (alkynes/alkynyl). When the term “aliphatic” is used without the “substituted” modifier only carbon and hydrogen atoms are present. When the term is used with the “substituted” modifier one or more hydrogen atom has been independently replaced by —OH, —F, —Cl, —Br, —I, —NH₂, —NO₂, —CO₂H, —CO₂CH₃, —CN, —SH, —OCH₃, —OCH₂CH₃, —C(O)CH₃, —N(CH₃)₂, —C(O)NH₂ or —OC(O)CH₃.

As used herein, “alkyl” refers to the radical of saturated aliphatic groups (i.e., an alkane with one hydrogen atom removed), including straight-chain alkyl groups, branched chain alkyl groups, cycloalkyl (alicyclic) groups, alkyl-substituted cycloalkyl groups, and cycloalkyl-substituted alkyl groups. A straight chain or branched chain alkyl has 30 or fewer carbon atoms in its backbone (e.g., C₁-C₃₀ for straight chains, and C₃-C₃₀ for branched chains), preferably 20 or fewer, more preferably 15 or fewer, most preferably 10 or fewer. Likewise, preferred cycloalkyls have 3-10 carbon atoms in their ring structure, and more preferably have 5, 6, or 7 carbons in the ring structure. The groups —CH₃ (Me), —CH₂CH₃ (Et), —CH₂CH₂CH₃ (n-Pr), —CH(CH₃)₂ (iso-Pr), —CH(CH₂)₂ (cyclopropyl), —CH₂CH₂CH₂CH₃ (n-Bu), —CH(CH₃)CH₂CH₃ (sec-butyl), —CH₂CH(CH₃)₂ (iso-butyl), —C(CH₃)₃ (tert-butyl), —CH₂C(CH₃)₃ (neo-pentyl), cyclobutyl, cyclopentyl, cyclohexyl, and cyclohexylmethyl are non-limiting examples of alkyl groups.

The term “alkyl” is intended to include both “unsubstituted alkyls” and “substituted alkyls” having one or more substituents replacing a hydrogen on one or more carbons of the hydrocarbon backbone. Exemplary substituents include, without limitation, halogen, hydroxyl, carbonyl (such as a carboxyl, alkoxycarbonyl, formyl, or an acyl), thiocarbonyl (such as a thioester, a thioacetate, or a thioformate), alkoxyl, phosphoryl, phosphate, phosphonate, phosphinate, amino, amido, amidine, imine, cyano, nitro, azido, sulfhydryl, alkylthio, sulfate, sulfonate, sulfamoyl, sulfonamide, sulfonyl, heterocyclyl, aralkyl or an aromatic or heteroaromatic moiety.

As used herein “heteroalkyl” refers to straight or branched chain, or cyclic carbon containing radicals, or combinations thereof, containing at least one heteroatom. Suitable heteroatoms include, but are not limited to, O, N, Si, P, Se, B, and S, wherein the phosphorous and sulfur atoms are optionally oxidized, and the nitrogen heteroatom is optionally quaternized. Heteroalkyls can be substituted as defined above for alkyl groups.

The term “alkanediyl” when used without the “substituted” modifier refers to a divalent saturated aliphatic group, with one or two saturated carbon atom(s) as the point(s) of attachment, a linear or branched, cyclo, cyclic or acyclic structure, no carbon-carbon double or triple bonds, and no atoms other than carbon and hydrogen. The groups, —CH₂— (methylene), —CH₂CH₂—, —CH₂C(CH₃)₂CH₂—, and CH₂CH₂CH₂— are non-limiting examples of alkanediyl groups.

The term “alkylidene” when used without the “substituted” modifier refers to the divalent group —CRR′ in which R and R′ are independently hydrogen, alkyl, or R and R′ are taken together to represent an alkanediyl having at least two carbon atoms. Non-limiting examples of alkylidene groups include: ═CH₂, ═CH(CH₂CH₃), and ═C(CH₃)₂. When any of these terms is used with the “substituted” modifier one or more hydrogen atom has been independently replaced by —OH, —F, —Cl, —Br, —I, —NH₂, —NO₂, —CO₂H, —CO₂CH₃, —CN, —SH, —OCH₃, —OCH₂CH₃, —C(O)CH₃, —N(CH₃)₂, —C(O)NH₂ or —OC(O)CH₃. The following groups are non-limiting examples of substituted alkyl groups: —CH₂OH, —CH₂Cl, —CF₃, —CH₂CN, —CH₂C(O)OH, —CH₂C(O)OCH₃, —CH₂C(O)NH₂, —CH₂C(O)CH₃, —CH₂OCH₃, —CH₂OC(O)CH₃, —CH₂NH₂, —CH₂N(CH₃)₂, and —CH₂CH₂Cl. The term “fluoroalkyl” is a subset of substituted alkyl, in which one or more hydrogen has been substituted with a fluoro group and no other atoms aside from carbon, hydrogen and fluorine are present. The groups, —CH₂F, —CF₃, and —CH₂CF₃ are non-limiting examples of fluoroalkyl groups. An “alkane” refers to the compound H—R, wherein R is alkyl.

The term “alkenyl” when used without the “substituted” modifier refers to an monovalent unsaturated aliphatic group with a carbon atom as the point of attachment, a linear or branched, cyclo, cyclic or acyclic structure, at least one nonaromatic carbon-carbon double bond, no carbon-carbon triple bonds, and no atoms other than carbon and hydrogen. Non-limiting examples of alkenyl groups include: —CH═CH₂ (vinyl), —CH═CHCH₃, —CH═CHCH₂CH₃, —CH₂CH═CH₂ (allyl), —CH₂CH═CHCH₃, and —CH═CH—C₆H₅. The term “alkenediyl” when used without the “substituted” modifier refers to a divalent unsaturated aliphatic group, with two carbon atoms as points of attachment, a linear or branched, cyclo, cyclic or acyclic structure, at least one nonaromatic carbon-carbon double bond, no carbon-carbon triple bonds, and no atoms other than carbon and hydrogen (e.g., —CH═CH—, —CH═C(CH₃)CH₂—, and —CH═CHCH₂—) are non-limiting examples of alkenediyl groups. When these terms are used with the “substituted” modifier one or more hydrogen atom has been independently replaced by —OH, —F, —Cl, —Br, —I, —NH₂, —NO₂, —CO₂H, —CO₂CH₃, —CN, —SH, —OCH₃, —OCH₂CH₃, —C(O)CH₃, —N(CH₃)₂, —C(O)NH₂ or —OC(O)CH₃. The groups, —CH═CHF, —CH═CHCl and —CH═CHBr, are non-limiting examples of substituted alkenyl groups. An “alkene” refers to the compound H—R, wherein R is alkenyl.

The term “alkynyl” when used without the “substituted” modifier refers to an monovalent unsaturated aliphatic group with a carbon atom as the point of attachment, a linear or branched, cyclo, cyclic or acyclic structure, at least one carbon-carbon triple bond, and no atoms other than carbon and hydrogen. As used herein, the term alkynyl does not preclude the presence of one or more non-aromatic carbon-carbon double bonds. The groups, —C≡CH, —C≡CCH₃, and —CH₂C≡CCH₃, are non-limiting examples of alkynyl groups. The term “alkynediyl” when used without the “substituted” modifier refers to a divalent unsaturated aliphatic group, with two carbon atoms as points of attachment, a linear or branched, cyclo, cyclic or acyclic structure, at least one carbon-carbon triple bond, and no atoms other than carbon and hydrogen. When these terms are used with the “substituted” modifier one or more hydrogen atom has been independently replaced by —OH, —F, —Cl, —Br, —I, —NH₂, —NO₂, —CO₂H, —CO₂CH₃, —CN, —SH, —OCH₃, —OCH₂CH₃, —C(O)CH₃, —N(CH₃)₂, —C(O)NH₂ or —OC(O)CH₃. An “alkyne” refers to the compound H—R, wherein R is alkynyl.

The term “aryl” when used without the “substituted” modifier refers to a monovalent unsaturated aromatic group with an aromatic carbon atom as the point of attachment, said carbon atom forming part of a one or more six-membered aromatic ring structure, wherein the ring atoms are all carbon, and wherein the group consists of no atoms other than carbon and hydrogen. If more than one ring is present, the rings may be fused or not fused. As used herein, the term does not preclude the presence of one or more alkyl group (carbon number limitation permitting) attached to the first aromatic ring or any additional aromatic ring present. Non-limiting examples of aryl groups include phenyl (Ph), methylphenyl, (dimethyl)phenyl, —C₆H₄—CH₂CH₃ (ethylphenyl), naphthyl, and the monovalent group derived from biphenyl. The term “arenediyl” when used without the “substituted” modifier refers to a divalent aromatic group, with two aromatic carbon atoms as points of attachment, said carbon atoms forming part of one or more six-membered aromatic ring structure(s) wherein the ring atoms are all carbon, and wherein the monovalent group consists of no atoms other than carbon and hydrogen. As used herein, the term does not preclude the presence of one or more alkyl group (carbon number limitation permitting) attached to the first aromatic ring or any additional aromatic ring present. If more than one ring is present, the rings may be fused or unfused. When these terms are used with the “substituted” modifier one or more hydrogen atom has been independently replaced by —OH, —F, —Cl, —Br, —I, —NH₂, —NO₂, —CO₂H, —CO₂CH₃, —CN, —SH, —OCH₃, —OCH₂CH₃, —C(O)CH₃, —N(CH₃)₂, —C(O)NH₂ or —OC(O)CH₃. An “arene” refers to the compound H—R, wherein R is aryl.

The term “aralkyl” when used without the “substituted” modifier refers to the monovalent group -alkanediyl-aryl, in which the terms alkanediyl and aryl are each used in a manner consistent with the definitions provided above. Non-limiting examples of aralkyls are: phenylmethyl (benzyl, Bn) and 2-phenyl-ethyl. When the term is used with the “substituted” modifier one or more hydrogen atom from the alkanediyl and/or the aryl has been independently replaced by —OH, —F, —Cl, —Br, —I, —NH₂, —NO₂, —CO₂H, —CO₂CH₃, —CN, —SH, —OCH₃, —OCH₂CH₃, —C(O)CH₃, —N(CH₃)₂, —C(O)NH₂ or —OC(O)CH₃. Non-limiting examples of substituted aralkyls are: (3-chlorophenyl)-methyl and 2-chloro-2-phenyl-eth-1-yl.

The term “heteroaryl” when used without the “substituted” modifier refers to a monovalent aromatic group with an aromatic carbon atom or nitrogen atom as the point of attachment, said carbon atom or nitrogen atom forming part of an aromatic ring structure wherein at least one of the ring atoms is nitrogen, oxygen or sulfur, and wherein the group consists of no atoms other than carbon, hydrogen, aromatic nitrogen, aromatic oxygen and aromatic sulfur. As used herein, the term does not preclude the presence of one or more alkyl group (carbon number limitation permitting) attached to the aromatic ring or any additional aromatic ring present. Non-limiting examples of heteroaryl groups include furanyl, imidazolyl, indolyl, indazolyl, methylpyridyl, oxazolyl, pyridyl, pyrrolyl, pyrimidyl, pyrazinyl, quinolyl, quinazolyl, quinoxalinyl, thienyl, and triazinyl. The term “heteroarenediyl” when used without the “substituted” modifier refers to an divalent aromatic group, with two aromatic carbon atoms, two aromatic nitrogen atoms, or one aromatic carbon atom and one aromatic nitrogen atom as the two points of attachment, said atoms forming part of one or more aromatic ring structure(s) wherein at least one of the ring atoms is nitrogen, oxygen or sulfur, and wherein the divalent group consists of no atoms other than carbon, hydrogen, aromatic nitrogen, aromatic oxygen and aromatic sulfur. As used herein, the term does not preclude the presence of one or more alkyl group (carbon number limitation permitting) attached to the first aromatic ring or any additional aromatic ring present. If more than one ring is present, the rings may be fused or unfused. When these terms are used with the “substituted” modifier one or more hydrogen atom has been independently replaced by —OH, —F, —Cl, —Br, —I, —NH₂, —NO₂, —CO₂H, —CO₂CH₃, —CN, —SH, —OCH₃, —OCH₂CH₃, —C(O)CH₃, —N(CH₃)₂, —C(O)NH₂ or —OC(O)CH₃.

The term “acyl” when used without the “substituted” modifier refers to the group —C(O)R, in which R is a hydrogen, alkyl, aryl, aralkyl or heteroaryl, as those terms are defined above. The groups, —CHO, —C(O)CH₃ (acetyl, Ac), —C(O)CH₂CH₃, —C(O)CH₂CH₂CH₃, —C(O)CH(CH₃)₂, —C(O)CH(CH₂)₂, —C(O)C₆H₅, —C(O)C₆H₄—CH₃, —C(O)CH₂C₆H₅, —C(O)(imidazolyl) are non-limiting examples of acyl groups. A “thioacyl” is defined in an analogous manner, except that the oxygen atom of the group —C(O)R has been replaced with a sulfur atom, —C(S)R. When either of these terms are used with the “substituted” modifier one or more hydrogen atom has been independently replaced by —OH, —F, —Cl, —Br, —I, —NH₂, —NO₂, —CO₂H, —CO₂CH₃, —CN, —SH, —OCH₃, —OCH₂CH₃, —C(O)CH₃, —N(CH₃)₂, —C(O)NH₂ or —OC(O)CH₃. The groups, —C(O)CH₂CF₃, —CO₂H (carboxyl), —CO₂CH₃ (methylcarboxyl), —CO₂CH₂CH₃, —C(O)NH₂ (carbamoyl), and —CON(CH₃)₂, are non-limiting examples of substituted acyl groups.

The term “alkoxy” when used without the “substituted” modifier refers to the group —OR, in which R is an alkyl, as that term is defined above. Non-limiting examples of alkoxy groups include: —OCH₃, —OCH₂CH₃, —OCH₂CH₂CH₃, —OCH(CH₃)₂, —OCH(CH₂)₂, —O-cyclopentyl, and —O-cyclohexyl. The terms “alkenyloxy”, “alkynyloxy”, “aryloxy”, “aralkoxy”, “heteroaryloxy”, and “acyloxy”, when used without the “substituted” modifier, refers to groups, defined as —OR, in which R is alkenyl, alkynyl, aryl, aralkyl, heteroaryl, and acyl, respectively. Similarly, the term “alkylthio” when used without the “substituted” modifier refers to the group —SR, in which R is an alkyl, as that term is defined above. When any of these terms is used with the “substituted” modifier one or more hydrogen atom has been independently replaced by —OH, —F, —Cl, —Br, —I, —NH₂, —NO₂, —CO₂H, —CO₂CH₃, —CN, —SH, —OCH₃, —OCH₂CH₃, —C(O)CH₃, —N(CH₃)₂, —C(O)NH₂ or —OC(O)CH₃. The term “alcohol” corresponds to an alkane, as defined above, wherein at least one of the hydrogen atoms has been replaced with a hydroxy group.

As used herein, “amine” and “amino” (and its protonated form) are art-recognized and refer to both unsubstituted and substituted amines, e.g., a moiety that can be represented by the general formula NRR′R″, represented by the structure:

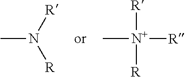

wherein R, R′, and R″ each independently represent a hydrogen, a heteroatom, an alkyl, a heteroalkyl, an alkenyl, —(CH₂)ₘ—Rc or R and R′ taken together with the N atom to which they are attached complete a heterocycle having from 4 to 8 atoms in the ring structure; Rc represents an aryl, a cycloalkyl, a cycloalkenyl, a heterocycle or a polycycle; and m is zero or an integer in the range of 1 to 8, and substituted versions thereof.

The term “alkylamino” when used without the “substituted” modifier refers to the group —NHR, in which R is an alkyl, as that term is defined above. Non-limiting examples of alkylamino groups include: —NHCH₃ and —NHCH₂CH₃. The term “dialkylamino” when used without the “substituted” modifier refers to the group —NRR′, in which R and R′ can be the same or different alkyl groups, or R and R′ can be taken together to represent an alkanediyl. Non-limiting examples of dialkylamino groups include: —N(CH₃)₂, —N(CH₃)(CH₂CH₃), and N-pyrrolidinyl. The terms “alkoxyamino”, “alkenylamino”, “alkynylamino”, “arylamino”, “aralkylamino”, “heteroarylamino”, and “alkylsulfonylamino” when used without the “substituted” modifier, refers to groups, defined as —NHR, in which R is alkoxy, alkenyl, alkynyl, aryl, aralkyl, heteroaryl, and alkylsulfonyl, respectively. A non-limiting example of an arylamino group is —NHC₆H₅. The term “amido” (acylamino), when used without the “substituted” modifier, refers to the group —NHR, in which R is acyl, as that term is defined above. A non-limiting example of an amido group is —NHC(O)CH₃. The term “alkylimino” when used without the “substituted” modifier refers to the divalent group ═NR, in which R is an alkyl, as that term is defined above. When any of these terms is used with the “substituted” modifier one or more hydrogen atom has been independently replaced by —OH, —F, —Cl, —Br, —I, —NH₂, —NO₂, —CO₂H, —CO₂CH₃, —CN, —SH, —OCH₃, —OCH₂CH₃, —C(O)CH₃, —N(CH₃)₂, —C(O)NH₂ or —OC(O)CH₃. The groups —NHC(O)OCH₃ and —NHC(O)NHCH₃ are non-limiting examples of substituted amido groups.

As used herein, “imine” and “imino” are art-recognized and refer to both unsubstituted and substituted imines, e.g., a moiety that can be represented by the general formula:

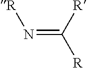

wherein R, R′, and R″ each independently represent a hydrogen, a heteroatom, an alkyl, a heteroalkyl, an alkenyl, —(CH₂)ₘ—Rc or R′ and R″ taken together complete a heterocycle having 4-12 atoms in the ring structure; Rc represents an aryl, a cycloalkyl, a cycloalkenyl, a heterocycle or a polycycle; and m is zero or an integer in the range of 1-8, or substituted versions thereof.

### I. Heterogeneous Catalysts and Preparation Thereof

Heterogeneous catalysts described herein comprise an organo-ruthenium complex immobilized to an aluminum-modified inorganic oxide. A surface of the aluminum-modified inorganic oxide support comprises a tetra-coordinated aluminum atom forming a chemical bond with an amino or imino nitrogen of the organo-ruthenium complex.

A heterogeneous catalyst according to the present disclosure can exhibit high catalytic activity under moderate conditions, and can be recycled without leaching or substantial loss of activity. For example, a heterogeneous catalyst according to one or more embodiments of the present disclosure can catalyze decomposition of formic acid for the generation of hydrogen gas at room temperature with a TOF greater than 47,000/h, a TON greater than 130,000, and be recycled up to 50 times, up to 75 times, or up to 100 times. A heterogeneous catalyst of the present disclosure can be recycled 100 times or more. Heterogeneous catalysts of the present disclosure promote a rapid reaction rate, and remain stable under the reaction conditions required for an effective hydrogen production system (e.g., on-board a vehicle). In one or more embodiments described herein, a heterogeneous catalyst of the present disclosure can be used to generate hydrogen from formic acid (or formate) without concomitant production of noxious byproducts or byproducts that will deactivate the catalyst. The catalytically generated hydrogen can be used for generating electricity, including the electricity required by a vehicle, for example.

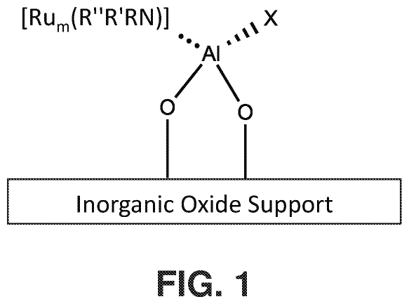

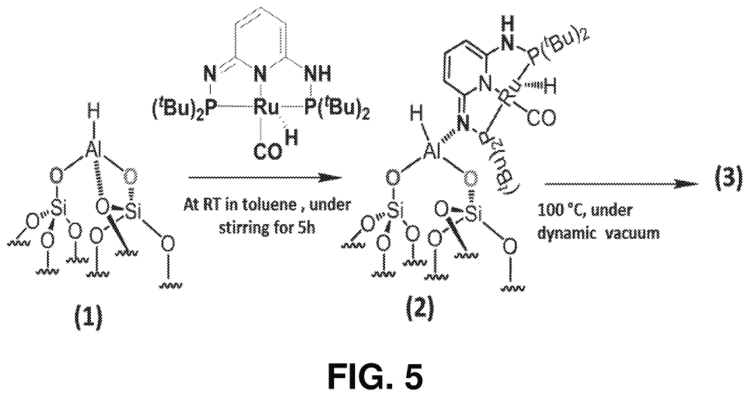

As shown in FIG. 1, a heterogeneous catalyst of the present disclosure can be generally described by the formula (M-O—)₂(X)Al—[N(RR′R″)Ruₘ], wherein (M-O—)₂(X)Al represents an aluminum-modified inorganic oxide support with M defined as a metal or metalloid of an inorganic oxide support, X defined as a hydride or halide, and wherein [N(RR′R″)Ruₘ] represents an organo-ruthenium complex, with N(RR′R″) defined as an organyl moiety (organic molecule or fragment) comprising an amino or imino nitrogen which is accessible for interacting with the supported aluminum atom, each R and R′ are independently selected from a hydrogen atom or a substituted or unsubstituted alkyl, heteroalkyl, cycloalkyl, heterocyclyl, aryl, and heteroaryl group; R″ is selected from a substituted or unsubstituted alkyl, heteroalkyl, cycloalkyl, heterocyclyl, aryl, and heteroaryl group; and m is 1 or 2. In some cases, the substituent can be a heterocyclyl, heteroaryl, alkylcycloalkyl, alkylaryl, alkylheterocyclyl, or alkylheteroary group. One or more atoms of the organyl moiety form a chemical bond with a ruthenium atom of the organo-ruthenium complex. The chemical bond can be a covalent, coordinate covalent, ionic, van der Waals type interaction, complexation interaction or other type of interaction. The interaction between the amino or imino nitrogen and the aluminum can be a covalent or coordinate covalent bond. Ruthenium can be present in the Ru(II) oxidation state. In a non-limiting example, a heterogeneous catalyst of the present disclosure can have the structure of complex (2) in FIG. 5 (where M is silicon, X is a hydride, [N(RR′R″)Ruₘ] is [Ru—H(9Bu-PN³P-pincer)(CO)]).

The amount of immobilized organo-ruthenium complex on the inorganic oxide support can be determined by elemental analysis. For example, elemental analysis of the heterogeneous catalyst can be performed to determine the ruthenium content. In some embodiments, the heterogeneous catalyst can include from about 0.001 to 10 parts by weight of ruthenium per 100 parts by weight of heterogeneous catalyst, such as about 0.05 to 5, about 0.1 to 3, about 0.1 to 2, about 0.5 to 1 part by weight of ruthenium per 100 parts by weight heterogeneous catalyst. In other embodiments, the amount of ruthenium present on the aluminum-modified inorganic oxide support is about 0.05, 0.1, 0.15, 0.2, 0.25, 0.3, 0.35, 0.4, 0.45, 0.5, 0.55, 0.6, 0.65, 0.7, 0.75, 0.8, 0.85, 0.9, 0.95, 1.0, 1.05, 1.10, 1.15, 1.2, 1.25, 1.3, 1.35, 1.4, 1.45, 1.5, 1.55, 1.6, 1.65, 1.7, 1.75, 1.8, 1.85, 1.9, 1.95, or 2.0 parts of ruthenium per 100 parts by weight of heterogeneous catalyst.

### A. Organo-Ruthenium Complexes

Suitable organo-ruthenium complexes of the heterogeneous catalysts of the present disclosure include organo-ruthenium complexes capable of promoting decomposition of formic acid (or formate) into CO₂ and hydrogen gas. Such complexes include ruthenium-based homogeneous catalysts comprising a bidentate, tridentate, or multidentate organyl moiety (e.g., an organic molecule or fragment). The organyl moiety can be a formally neutral ligand or formally negative ligand.

In one or more embodiments of the present disclosure, the organyl moiety can be a multidentate ligand, such as a pincer-type ligand of the form [XZY] where Z is the central, anchoring lewis donor connected to the side arm lewis donor moieties X and Y, wherein at least one of the side arms comprises an accessible amino or imino nitrogen.

For example, in some embodiments of the present disclosure, the organo-ruthenium complex of the heterogeneous catalyst is a ruthenium PN³ pincer-type complex according to formula (I):

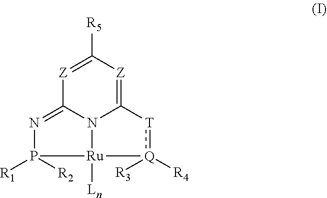

wherein: R₁ and R₂, are each independently an alkyl_{(C≤12)}, aryl_{(C≤12)}, or aralkyl_{(C≤12)} group, or a substituted version of any of these groups;

R₃ and R₄, if present, are each independently an alkyl_{(C≤12)}, aryl_{(C≤12)}, or aralkyl_{(C≤12)} group, or a substituted version of any of these groups;

R₅ is an alkyl_{(C≤12)}, aryl_{(C≤12)}, or aralkyl_{(C≤12)} group, or a substituted version of any of these groups;

each Z is independently CR₆, N or P;

R₆ is a hydrogen atom or an alkyl_{(C≤12)}, aryl_{(C≤12)}, aralkyl_{(C≤12)}, amino, hydroxyl, or alkoxyl group, or a substituted version of any of these groups;

T is a N, NR₇, C, or CR₈; R₇ and R₈ are each independently a hydrogen, an alkyl_{(C≤12)}, aryl_{(C≤12)}, or aralkyl_{(C≤12)} group, or a substituted version of any of these groups;

L is a anionic ligand or a neutral ligand and n is 0, 1, or 2;

Q is P or N; and

optionally wherein T and Q, together, form a 5 or 6 membered heterocyclic ring; wherein the heterocyclic ring can optionally be substituted with one or more heteroatoms and or one or more sites of the heterocyclic ring are substituted with one or more alkyl_{(C≤12)}, aryl_{(C≤12)}, or aralkyl_{(C≤12)} group, or a substituted version of any of these groups, and optionally wherein the heterocyclic ring can have a fused ring attached thereto, provided when T and Q form a 5 or 6 membered heterocyclic ring, one or both of R₃ and/or R₄ are not present; and

[symbol] designates a single bond or a double bond.

The ruthenium PN³ pincer-type complex according to formula (I) can be immobilized to a tetra-coordinated aluminum grafted to an inorganic oxide support by the nitrogen of the imine arm. The stereochemistry of the ruthenium PN³ pincer-type complex is not limited to a planar structure but is depicted this way for convenience.

In one or more embodiments, the organo-ruthenium complex comprises a ruthenium PN³ pincer-type complex according to formula (I) wherein Z is C, T is NH, Q is P, R₅ is a hydrogen and R₁, R₂, R₃, and R₄ are each an alkyl_{(C≤12)} group. For example, each R₁, R₂, R₃, and R₄ can be a t-butyl group.

In one or more embodiments, the organo-ruthenium complex comprises a ruthenium PN³ pincer-type complex according to formula (I) wherein T is CH₂, Q is N, and R₁, R₂, R₃, and R₄ are each an alkyl_{(C≤12)} group. For example, R₁ and R₂ can be t-butyl groups and R₃ and R₄ can be ethyl groups.

In one or more embodiments, the organo-ruthenium complex comprises a ruthenium PN³ pincer-type complex according to formula (I) wherein T is C, Q is N and T and Q form the following structure:

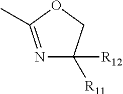

wherein: R₁₁ and R₁₂, each independently, are a hydrogen atom or alkyl_{(C≤12)}, aryl_{(C≤12)}, or aralkyl_{(C≤12)} group, or a substituted version of any of these groups. For example, R₁₁ and R₁₂ can each be a methyl group.

In any of the embodiments above for the ruthenium PN³ pincer-type complex according to formula (I), the ruthenium atom can be complexed with the organic moiety and one or two additional ligands (L), selected from a carbonyl group, a halide, or a hydrogen atom. In a preferred embodiment, the ruthenium is also bonded to carbon monoxide and a hydrogen atom.

In one or more embodiments of the present disclosure, the organo-ruthenium complex of the heterogeneous catalyst is a bidentate ruthenium N,N′-diimine ligand complex according to formula (II)

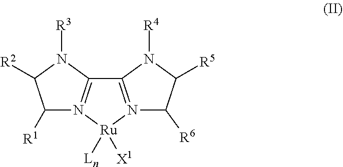

wherein: R¹, R², R³, R⁴, R⁵, and R⁶ are each independently selected from hydrogen, substituted or unsubstituted alkyl, and substituted or unsubstituted aryl;

X¹ is a halide, a hydride, or a formate ion;

L is a neutral ligand or an anionic ligand, and n is 0, 1, or 2.

In some embodiments of the N,N′-diimine ligand complex of Formula (II), R¹, R², R³, R⁴, R⁵, and R⁶ are each hydrogen, and L is a substituted aryl. For example, L can be represented by the following structure:

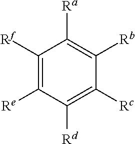

wherein R^{a}, R^{b}, R^{c}, R^{d}, R^{e}, and R^{f} are each independently selected from hydrogen and substituted or unsubstituted alkyl (e.g., L can be p-cymene), and X¹ is chloride, bromide, or fluoride.

In some cases, the organo-ruthenium complex is a ruthenium N,N′-diimine ligand complex according to formula (III):

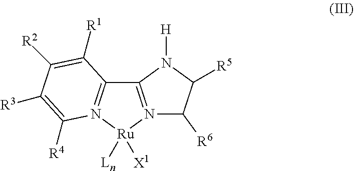

wherein R¹, R³, R⁴, R⁵, and R⁶ are each independently selected from hydrogen, substituted or unsubstituted alkyl, and substituted or unsubstituted aryl;

R² is hydrogen, substituted or unsubstituted alkyl, substituted or unsubstituted aryl, N(CH₃)₂, NH₂, OH, CH₃O, C₂H₅₀, CH₃, F, I, CF₃, CN, or NO₂;

L is a neutral ligand or an anionic ligand; n is 0, 1, or 2; and

X¹ is a halide, a hydride, or a formate ion.

Methods of synthesizing the organo-ruthenium complexes described above are known to the person of ordinary skill in the art. The compounds described herein can be prepared from readily available starting materials. The compounds described herein can be prepared in a variety of ways and using various synthetic methods. At least some of these methods include the use of synthetic organic chemistry. For example, a RuPN3P organo-ruthenium catalyst of Formula (I) can be synthesized by adding a solution of ruthenium in organic solvent (e.g., tetrahydrofuran (THF)) a solution of an tBu2PN3P organyl moiety and heating for a sufficient time for Ru coordination (e.g., about 65° C. for about 12 hours). After washing and drying the complex, dearomatization of the pyridine ring can be achieved by adding potassium tert-butoxide (KOtBu) in solution. All synthesis reactions can be conducted under inert gas protection.

Additionally, compound synthesis can involve the protection and deprotection of various chemical groups. The use of protection and deprotection and the selection of appropriate protecting groups can be determined.

Generally the complexes can be prepared by the methods described in U.S. Pat. No. 8,698,351 B2 entitled “Phospho-amino Pincer-Type Ligands and Catalytic Metal Complexes Thereof”, PCT Publication WO 2015/083007A1 entitled “Metal-ligand cooperative catalysis through N—H arm deprotonation/pyridine dearomatiztion for efficient hydrogen generation from formic acid” and PCT Publication WO 2018/002850 A1 entitled “Hydrogen Generation from Formic Acid Catalyzed by a Metal Complex under Amine-free and Aqueous Conditions”, the contents of which are hereby incorporated by reference in their entirety.

### B. Inorganic Oxide Supports

The heterogeneous catalysts of the present disclosure include an aluminum-modified inorganic oxide. A suitable aluminum-modified inorganic oxide support is an insoluble solid that prevents dissolution of the catalyst in a contacting liquid (e.g., the liquid phase of the reaction medium). In one or more embodiments, the inorganic oxide support has high thermal, chemical, and mechanical stability.

The composition of the inorganic oxide support can be any metal oxide, metalloid oxide, mixed metal oxide, or mixed metal-metalloid oxide having the general formula: MOₐ, where a can be any integer (i.e., 1, 2, 3, . . . n) such that the d⁰ configuration and oxidation state of M is maintained. In one or more embodiments of the present disclosure, M can be Si, Al, Mg, Mn, Ca, Sr, Cr, Zn, Zr, Ti, Nb, or a mixture thereof. In one or more embodiments M is Si, and the inorganic oxide support is free of other metals or metalloids.

Exemplary metal oxide or metalloid oxide of the heterogeneous catalysts of the present disclosure can include silica, silica-alumina, γ-alumina, a porous silica (e.g. MCM-41, SBA-15, and KCC-1), a zeolite, a porous zeolite, and/or a combination thereof. Exemplary inorganic oxide supports include alpha, beta or theta alumina (Al₂O₃), activated Al₂O₃, silicon dioxide (SiO₂), titanium dioxide (TiO₂), magnesium oxide (MgO), calcium oxide (CaO), strontium oxide (SrO), zirconium oxide (ZrO₂), chromium oxides (CrO, CrO₂, CrO₃, CrO₅, Cr₂O₃, or mixed valence species, such Cr₈O₂₁), zinc oxide (ZnO), lithium aluminum oxide (LiAlO₂), magnesium aluminum oxide (MgAlO₄), manganese oxides (MnO, MnO₂, Mn₂O₄), lanthanum oxide (La₂O₃), activated carbon, zeolites, activated clays, silicon carbide (SiC), diatomaceous earth, magnesia, aluminosilicates, or calcium aluminate. In some cases, the inorganic oxide support is silica, and is free of any other oxide.

In some cases, the inorganic oxide support is present in or on an organic-inorganic hybrid material, such as a Metal-Organic Framework (MOF). MOFs are constructed by connecting inorganic nodes and organic linkers through coordination bonds. The inorganic nodes can be metal clusters or metal ions. Generally, the inorganic nodes of MOFs can be constructed from monovalent (Cu⁺, Ag⁺, etc.), divalent (Mg²⁺, Mn²⁺, Fe²⁺, Co²⁺, Ni²⁺, Cu²⁺, Zn²⁺, Cd²⁺, etc.), trivalent (Al³⁺, Sc³⁺, V³⁺, Cr³⁺, Fe³⁺, Ga³⁺, In³⁺, lanthanides³⁺, etc.), or tetravalent (Ti⁴⁺, Zr⁴⁺, Hf⁴⁺, Ce⁴⁺, etc.) metal cations. Suitable MOFs will include accessible hydroxide groups. The porous structure of MOFs results in single metal-oxide clusters accessible by the substrates. For example, a suitable MOFs can be represented as an array of nanosized metal-oxide clusters periodically arranged within a crystal lattice.

A suitable inorganic oxide support of the present disclosure have any shape and be any size required for the end use of the heterogeneous catalyst. For example, the inorganic oxide support can be a monolith such as an extruded ceramic foam or block with parallel channels. In one or more embodiments described herein, the inorganic oxide support is a divided solid (e.g., a powder) including a plurality of granules, microparticles or nanoparticles. The term “microparticle” as used herein refers to a particle having a maximum diameter between 1 and 1000 μm. The term “nanoparticle” as used herein refers to a particle having a maximum diameter of between 1 and 5000 nm. In some cases, the inorganic oxide support can be a nanoparticle or plurality of nanoparticles having a maximum diameter between about 50 and 1500 nm. Alternatively, the inorganic oxide support can be an inorganic oxide present on a metallic surface (e.g., a metallic nanoparticle). In some cases, the inorganic oxide is deposited as a continuous or discontinuous layer on the surface of a support (e.g., a silica-coated metallic monolith).

The inorganic oxide support can be non-porous, porous, or a combination of non-porous and porous material, e.g., a material in which the pores (cavities, channels or interstices) are restricted to a specific region of the material. The porous region can include a surface of the inorganic oxide support that is accessible for contact with reagent or substrate, The surface can be an outer surface, an inner surface (e.g., the inner surface of a tubular structure), or a surface of a substructure of the support (e.g., a surface of a fiber or thin sheet within the support). The chemical and mechanical characteristics of a porous material vary depending on the size, arrangement and shape of the pores, as well as the porosity (the ratio of the total pore volume relative to the apparent volume of the material).

In one or more embodiments of the present disclosure, the inorganic oxide support is a mesoporous material (e.g., having pores with a diameter of about 2-50 nm). Suitable mesoporous material includes disordered or ordered mesoporous molecular sieve material from the MSU, SBA, MCM, HMS, OMS, TUD, MCF, and FSM families. For example, mesoporous material such as MCM-41, MCM-48, MCM-50, SBA-1, SBA-3, SBA-12, SBA-15, SBA-16, KIT-1, KIT-6, FDU-1, FDU-12, FSM-16, MCF, MSU-X, MSU-H, and HMS silica can be used as the inorganic oxide support. In some cases, the mesoporous material is highly ordered with a hexagonal mesostructure (i.e., array of uniform channels that form tubular pores (e.g., having two openings)). The average pore size can be within a range of about 1-50 nm, such as about 5-50 nm, about 10-30 nm. about 3-10 nm or about 1-8 nm. For example, the mesoporous material can have an average pore diameter of about 6 nm. In some cases, the mesoporous material has a pore volume of about 0.02-1.2 cm³/g, such as about 0.02-0.22 cm³/g, about 0.7-1.2 cm³/g, or about 0.85-0.95 cm³/g. The mesoporous material can be characterized by surface area.

For example, a suitable mesoporous material for an inorganic support can have a Brunauer-Emmett-Teller (BET) surface area that is equal to or greater than 1000 m²/g. Alternatively, the mesoporous material can have a surface area of about 275-1200 m²/g.

Suitable mesoporous materials include fibrous mesoporous material. Accordingly, in one or more embodiments of the present disclosure, the inorganic oxide support is a nanoparticle having a fibrous morphology such as a mesoporous inorganic oxides of the KAUST Catalysis Center (KCC) family.

Fibrous mesoporous material includes a plurality of fibers or thin sheets oriented radially in three dimensions from the interior thereby forming a nanoparticle having a wrinkled, nanoflower, lamellar, or fibrous appearance. The fibrous morphology can allow enhanced access for loading of active sites (e.g., organometallic sites) relative to mesoporous material having tubular pores. As used in relation to mesoporous inorganic oxides, the term “fiber” refers to a slender, threadlike structure that includes a length and a maximal thickness. A “thin sheet” refers to a structure that is broader than a fiber, and which is about 3-5.5 nm thick, such as about 3.5-5 nm thick or about 4 nm thick.

The number of fibers or thin sheets present in suitable fibrous nanoparticle can vary. In some embodiments, the fibrous nanoparticle includes at least about 100 fibers or thin sheets, such as at least about 1000, at least about 10,000, at least about 100,000, or at least about 1,000,000 fibers or thin sheets. The thickness of the fiber or thin sheet can vary or be uniform along the length of the structure, and different fibers or thin sheet can be of variable thicknesses or of uniform thicknesses. Similarly, the fibers or thin sheets can be of variable length or can be of uniform length. In some embodiments, the fibers or thin sheets are of varying lengths and varying thicknesses. In other embodiments, the fibers or thin sheets of a single nanoparticle are of uniform thickness and length. The fibers or thin sheets of a single nanoparticle may be of a length between about 1, 10, 50, 100, 500, or 1000 nm and about 2000, 2500, 3000, 3500, 4000, or 5000 nm. In particular embodiments, each fiber or thin sheet has a length of between about 1-1200, about 10-900 nm, about 50-800 nm, about 100-700 nm, or 500-600 nm. In some cases, the maximum thickness of a particular fiber or thin sheet ranges from about 1 nm to about 50 nm, from about 1 nm to about 10 nm, or from about 4 nm to about 10 nm. In some embodiments, each fiber or thin sheet has a length of between about 1 nm and about 1000 nm and a thickness of between about 1 nm and about 50 nm.

In some embodiments, the fibrous nanoparticle is substantially spherical (e.g., a nanosphere). In particular embodiments, the nanoparticle is a fibrous silica nanosphere. A suitable fibrous nanosphere or fibrous silica nanosphere can have a diameter within a range of about 200-1100 nm, about 200-600 nm, or about 200-400 nm.

In one or more embodiments of the present disclosure the inorganic oxide support is a fibrous silica nanosphere, or a plurality of fibrous silica nanospheres having a diameter of about 200, 240, 270, 300, 320, 340, 360, 380, 400, 430, 460, 500, 550, 600, 650, 700, 750, 800, 850, 900, 950, 1000, or 1100 nm.

The fibrous nanosphere or fibrous silica nanosphere can be characterized by its surface area. For example, the BET surface area of a fibrous silica nanosphere can be greater than about 350 m²/g, such as equal to or greater than about 380, 400, 520, 550, 600, 700, 800, 900, 1000, or 1200 m²/g.

A fibrous nanosphere or fibrous silica nanosphere can be characterized by pore volume. For example, a fibrous nanosphere or fibrous silica nanosphere can have a pore volume within the range of about 0.6-2.2 cm³/g, such as about 0.7, 1.0, 1.3, 1.5, 1.7, 1.9, 1.95, 2.0, 2.1. or 2.15 cm³/g.

A fibrous nanosphere or fibrous silica nanosphere can possess radially oriented pores, the size of which can increase from the center of the nanoparticle to its outer surface. In some cases, a fibrous nanosphere or fibrous silica nanosphere has a pore size distribution within the range of about 3-25 nm, such as pores of about 11-21 nm or about 8-12 nm. Alternatively, a fibrous nanosphere or fibrous silica nanosphere can include pores of about 3, 4, or 5.5 nm. In some cases, the pores of a fibrous nanosphere or fibrous silica nanosphere can be characterized by a bimodal pore size distribution, wherein pores within the range of about 8-21 nm and pores within the range of about 3-5.5 nm are present in the same nanosphere. In one or more embodiments, the inorganic oxide support is a fibrous silica nanosphere of the KCC-1 family having 8 nm pores or 4 nm pores.

An inorganic oxide support as described above can be made using methods that are known in the art and using materials that are readily available. For example, sol-gel template-free and template-structured methods can be utilized with inorganic oxide precursors which are known to the skilled artisan for providing inorganic oxide supports with tunable pore sizes, particle sizes, surface morphology or film thickness.

A suitable inorganic oxide support of the present disclosure includes or is treated to include or control the surface hydroxyl groups. In some cases, the hydroxyl groups are isolated and homogeneously (or evenly) distributed on a surface of the support. In one or more embodiments, the hydroxyl groups present on the inorganic oxide support are in the form of isolated and homogeneously (or evenly) distributed silanol groups. For example, a silica support material contains silanol [≡Si—OH] groups that are homogeneously (or evenly) distributed on a surface, isolated from each other, and accessible for contacting an aluminum alkyl compound to provide the aluminum-modified inorganic oxide support.

In one or more embodiments, the inorganic oxide support is dehydroxylated to provide hydroxyl groups. For example, the inorganic oxide support is dehydroxylated by thermal treatment or chemical treatment, or a combination of thermal and chemical treatments in any order. Suitable thermal treatments for dehydroxylation can include heating the inorganic oxide support at a temperature sufficient to achieve an inorganic oxide support having a desired hydroxyl density. Thermally treated inorganic oxide support material can be identified by the formula “support_{temp. ° C.”. For example, “SBA-}15700” refers to material of the SBA-15 family that has been dehydroxylated at 700° C. The hydroxyl density decreases with the increase of the applied temperature.

Heating may be performed in air or any other suitable atmosphere. Heating may be performed at reduced pressure to facilitate removal of gases evolving from dehydroxylation. In some cases, thermal treatment can be performed under high vacuum. For example, mesoporous silica material, such as material from the SBA-15 or KCC-1 families, can be treated between 200° C. and 1000° C. under a dynamic vacuum (e.g., 10⁻⁵ mbar) for a period of time sufficient to make isolated —OH groups. The isolated —OH groups can be present as one or more types of silanols (e.g., isolated, germinal, or vicinal silanols). During dehydroxylation under high temperature with a dynamic vacuum condensation between the adjacent hydroxyl groups can occur leading to the evolution of water molecules and the formation of the siloxane bridges (≡Si—O—Si≡). In one or more embodiments of the present disclosure, treating the inorganic oxide support comprises heating mesoporous silica particles or fibrous silica nanospheres at 500-800° C. under dynamic vacuum to achieve a surface hydroxyl groups density of about 0.1-2 OH/nm², or about 0.5-1.5 OH/nm², or for a duration of about 20-36 hours. For example, the mesoporous silica particles or fibrous silica nanospheres can be heated at about 700° C. for a duration of about 30 hours to yield a dehydroxylated silica product with a surface OH density of about 0.6-0.8 OH/nm² or about 0.7 OH/nm². The OH density of an inorganic oxide support can be determined empirically using chemical, isotopic exchange, and/or spectroscopic methods. For example, the surface ≡Si—OH concentration of treated mesoporous silica particles of fibrous silica nanospheres can be determined by titration with a solution of MeLi in ether and the amount of methane evolve quantified (e.g., by gas chromatography). Alternatively, the surface silanol concentration can be measured by determining the number of active hydrogens using a modified Zerewitinoff method.

### C. Aluminum-Modified Inorganic Oxide Supports

Heterogeneous catalysts of the present disclosure include an aluminum-modified inorganic oxide support. In one or more embodiments, the aluminum-modified inorganic oxide support includes one or more well-defined bipodal and tetrahedral aluminum sites. A bipodal and tetrahedral aluminum site confers a strong Lewis acid character to the surface of the inorganic oxide support and facilitates the immobilization of the amino or imino nitrogen of the organo-ruthenium complex. In some cases, immobilization of the imino nitrogen of the organo-ruthenium complex provides superior results relative to immobilization of the amino nitrogen.

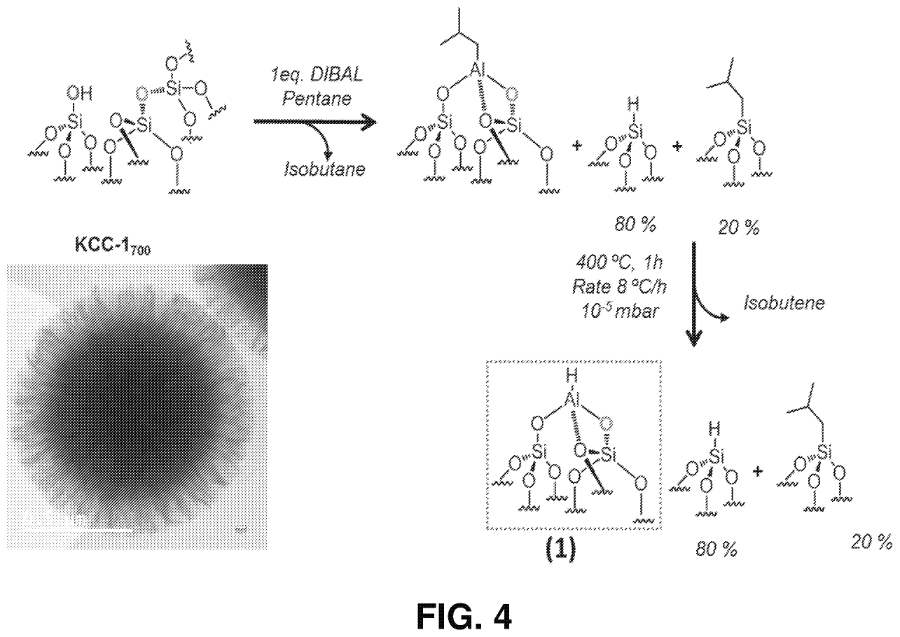

In one or more embodiment of the present disclosure, the aluminum-modified inorganic oxide support is prepared by grafting an aluminum atom to or on the inorganic oxide support to form a bipodal and tetrahedral aluminum complex of the formula X—Al(O-M)₂(M-O-M), wherein M is a metal of the inorganic oxide support (as described above) and X is a halide or hydride. For example, when M is silicon, the surface of the inorganic oxide support including a bipodal and tetrahedral aluminum hydride site can have the structure of aluminum hydride complex (1) in FIG. 4. When a plurality of aluminum atoms are grafted to or on the inorganic oxide support, the aluminum atoms can be spatially isolated from one another. In one or more embodiments, each aluminum atom of the plurality will exhibit substantially the same energy of interaction with the organo-ruthenium complex.

The aluminum to oxygen bond (Al—O-M) can be formed by reacting an aluminum alkyl precursor with an accessible hydroxyl group on a surface of the inorganic oxide support to form an aluminum alkyl-modified inorganic oxide support. For example, an aluminum alkyl precursor can be reacted with a surface silanol group on the inorganic oxide support. The aluminum alkyl precursor can be an aluminum alkyl, aluminum alkyl halide (aluminum halo-alkyl), or aluminum alkyl hydride compound as represented by formula AlR₁R₂R₃, wherein R₁, R₂, and R₃ are the same or different and are selected from hydrogen, halogen (e.g., fluorine, chlorine, bromine, and iodine), linear or branched C₁-C₁₀ alkyl groups. The aluminum alkyl precursor can be selected based on its efficacy for producing a tetracoordinated aluminum site. Preferably, the precursor has a dimeric or trimeric form in solution. Trialkylaluminium compounds and dialkylaluminium hydrides are usually dimer or trimer with alkyl and hydride-bridges, while alkylaluminium halides are normally associated through halide-bridges. Lower homologs of tri-alkylaluminum compounds are well known to form dimeric R₂Al(μ-R)₂AlR₂ species. Triisobutyl aluminum (TIBA), which is monomeric in solution, is not effective for providing tetracoordinated aluminum. The precursor can include two or more C₁-C₄ alkyl groups, such as a trialkyl compound wherein R₁, R₂. and R₃ can be selected from C₁-C₄ alkyl groups. Alternatively, R₁ and R₂ can be ethyl, n-butyl or isobutyl, and R₃ can be hydrogen, chlorine, or bromine. In some embodiments, the aluminum alkyl precursor is selected from trimethyl aluminum (TMA), triethyl aluminum (TEA), diethyl aluminum chloride, diisobutyl aluminum (DIBAL), or diisobutyl aluminum hydride (DIBAL-H). In a preferred embodiment, the aluminum alkyl precursor is DIBAL or DIBAL-H.

The maximum quantity of aluminum alkyl precursor which reacts with the inorganic oxide will depend on the hydroxyl content of the inorganic oxide support. The amount of aluminum alkyl precursor brought into contact with the inorganic oxide support can be a stoichiometric ratio. The reaction can include dissolving the aluminum alkyl precursor in a thoroughly dried inert solvent, e.g. a lower alkane, cycloalkane, or aromatic solvent having for example 3 to 20 preferably 5 to 12 carbon atoms per molecule and mixing the solution with the inorganic oxide support. Inorganic and organometallic compounds can be highly reactive toward water and oxygen may require the use of air-free manipulations in addition to dry and deoxygenated solvents. Employing a Schlenk line or high vacuum line can allow for proper manipulation. Alternatively, the reaction may be carried out in the gas phase by entraining the aluminum alkyl in a dry inert gas stream which may be passed over a fixed bed or into a fluidized bed of the inorganic oxide support.

The inorganic oxide support and aluminum alkyl may be brought into contact over a wide range of temperatures, e.g. temperatures in the range −50° C. to 150° C., about 20° C. to 100° C. or about 20° C. to 50° C. Control of the temperature may be achieved by carrying out the reaction in the presence of a solvent which is allowed to evaporate, carrying off the heat of the reaction. Lower alkanes (butanes, pentanes and hexanes) and cycloalkanes can be suitable solvents for this purpose. The duration of the reaction with the aluminum alkyl may vary over a moderately wide range, for example, between 0.1 hour and 24 hours. In one or more embodiments, the inorganic oxide support (e.g., dehydroxylated mesoporous material from the SBA-15 or KCC-1 family), and the aluminum alkyl are brought into contact at room temperature for about an hour. Excess aluminum alkyl can be washed from the inorganic oxide support with a suitable solvent (e.g., dry cyclohexane or pentane).

The process of reacting the aluminum alkyl precursor with the inorganic oxide support can be performed in one step. The aluminum alkyl-modified inorganic support can be thermally treated in a vacuum to replace the alkyl groups on the aluminum atom with hydrogen, thereby forming a bimodal tetrahedral aluminum hydride complex. For example, an aluminum hydride complex can be generated by heating the aluminum alkyl-modified inorganic support to about 400° C. for about 1 hour to evolve the alkyl moiety via β-H elimination. The surface acidity of the aluminum-modified inorganic oxide support can be characterized by measuring the pyridine adsorption/desorption characterized by IR spectroscopy or ¹⁵N solid state NMR, for example.

In one or more embodiments of the present disclosure the aluminum alkyl-modified inorganic support is an aluminum alkyl-modified mesoporous material such as aluminum alkyl-modified mesoporous silica particles having a hexagonal mesostructure (e.g., SBA-15) or aluminum alkyl-modified fibrous silica nanospheres as described above (e.g., KCC-1).

In some embodiments, the amount of grafted aluminum present on the inorganic oxide support ranges from about 0.1 to 99.9 parts by weight of grafted aluminum per 100 parts by weight of aluminum-modified inorganic oxide support, such as about 0.5 to 50, about 1 to 30, about 1 to 20, about 5 to 10 parts by weight of grafted aluminum per 100 parts by weight of aluminum-modified inorganic oxide support. In other embodiments, the amount of grafted aluminum present on the aluminum-modified inorganic oxide support is about 0.5, 1, 1.5, 2, 2.5, 3, 3.5, 4, 4.5, 5, 5.5, 6, 6.5, 7, 7.5, 8, 8.5, 9, 9.5, 10, 10.5, 11, 11.5, 12, 12.5, 13, 13.5, 14, 14.5, 15, 15.5, 16, 16.5, 17, 17.5, 18, 18.5, 19, 19.5, or 20 parts of grafted aluminum per 100 parts by weight of aluminum-modified inorganic oxide support.

Methods of preparing a heterogeneous catalyst of the present disclosure can include some or all of the preparative steps described above, immobilization of the organo-ruthenium complex to the aluminum-modified inorganic oxide support and thermally treating the immobilized complex.

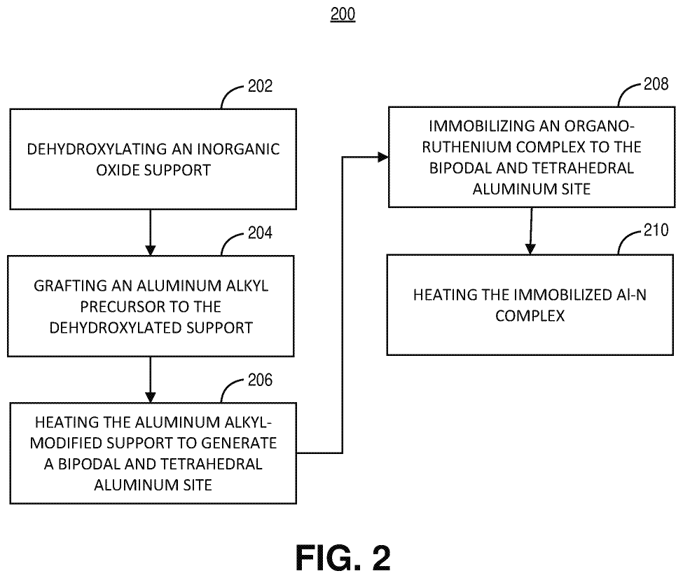

Referring to FIG. 2, method 200 describes an embodiment for synthesizing a heterogeneous catalyst for decomposition of formic acid into hydrogen gas and CO₂.

In block 202, the method includes dehydroxylating an inorganic oxide support. The inorganic oxide support can be selected from the inorganic oxide supports described above. In a non-limiting example, the inorganic oxide support is a mesoporous silica material (e.g., a fibrous silica nanosphere of the KCC-1 family). Block 202 can include synthesizing the inorganic oxide support. In some embodiments of method 200, dehydroxylating includes heating the inorganic oxide support to achieve a surface hydroxy density of about 0.1-2 OH/nm² or about 0.5-1.5 OH/nm². In some cases, dehydroxylating includes heating the inorganic oxide support for 24-36 hours at a temperature of about 500-800° C. In some cases, dehydroxylating can include two or more stages of heating. For example, a first stage can include heating for about 3 hours at 150° C. and a second stage can include about 16 hours at 700° C. with a rate of 60° C.

In block 204, the method includes grafting an aluminum alkyl precursor to the dehydroxylated support to provide an aluminum alkyl-modified support. The aluminum alkyl precursor can be selected from the precursors described above (e.g., aluminum alkyls that form dimers or trimers). In an non-limiting embodiment, grafting includes reacting an isolated silanol group of the mesoporous silica material (e.g., a dehydroxylated nanosphere of the KCC-1 family) with DIBAL or DIBAL-H and pentane under inert atmosphere. In some cases, grafting can include contacting the DIBAL or DIBAL-H with the dehydroxylated support for about 1 hour at room temperature. For example, grafting of DIBAL or DIBAL-H on dehydroxylated mesoporous silica material can result in the presence of a bis-siloxy aluminum isobutyl tetra-coordinated complex (formulated as [(≡SiO—)₂≡Si—O—Si≡)—Al—CH₂CH(CH₃)₂]) on a surface of the inorganic oxide support. In some cases, block 204 can include one or more washing steps to remove unreacted precursor from the aluminum alkyl-modified support. For example, the aluminum alkyl-modified support can be washed twice with pentane. In some cases, block 204 can further include drying the aluminum alkyl-modified support under a dynamic vacuum (e.g., 10⁻⁵ mbar).

In block 206, the method includes thermally treating the aluminum alkyl-modified support to generate a bipodal and tetrahedral aluminum site on a surface of the dehydroxylated support. The bipodal and tetrahedral aluminum site can be a tetra-coordinated aluminum hydride site. Thermally treating the aluminum alkyl-modified support can include heating at 400° C. for 1 hour with a rate of 8° C./hour under dynamic vacuum. Block 206 can exclude the presence of hydrogen.

In block 208, the method includes immobilizing an organo-ruthenium complex to the bipodal and tetrahedral aluminum site of the support. As described above, a suitable organo-ruthenium complex is characterized by the presence of an accessible amino or imino nitrogen and the specificity of the complex for promoting decomposition of formic acid into hydrogen gas and CO₂. Immobilizing can include contacting the aluminum-modified inorganic oxide support (e.g., the aluminum modified mesoporous silica material) with a solution of the organo-ruthenium complex for a period of time sufficient to allow the amino or imino nitrogen to interact with an aluminum atom of the support. The conditions of the reaction can be varied based on the affinity of the complex to the inorganic oxide support to minimize non-specific interactions. For example, the conditions can be adjusted to minimize or prevent adsorption or absorption to the inorganic oxide support. In some cases, a suitable solvent for the organo-ruthenium complex is an organic solvent selected from the group consisting of acetonitrile, acetone, dialkyl ketones, cyclic ketones, toluene, dimethyl sulfoxide (DMSO), benzene, toluene, o-, m- or p-xylene, mesitylene (1,3,5-trimethyl benzene), dioxane, tetrahydrofuran (THF), dimethoxyethane (DME), anisole, methylene chloride, and cyclohexane, or a mixture thereof. In some cases, the aluminum-modified inorganic oxide support is in contact with the organo-ruthenium complex solution for a duration of 3-8 hours or about 5 hours. In some cases, the reactants remain in contact until a change in color of solution is observed or detected. For example, the initial color of the organo-ruthenium complex solution can be brown, brown-red, red, red-orange, orange, orange-yellow, yellow, or green, and turn colorless when the amino or imino nitrogen of the organo-ruthenium complex forms a chemical bond with the aluminum atom. In some cases, immobilizing is performed at room temperature. Alternatively, the temperature can be controlled by immersion in liquid nitrogen. In some cases, the solution of the organo-ruthenium can be mixed with the aluminum-modified inorganic metal oxide support by stirring, agitating, shaking, and other methods known in the art for dissolving and/or mixing. After the reaction is complete, the immobilized catalyst can be washed with solvent and dried under dynamic vacuum to remove any trace of solvent.

The methods or processes described herein can be monitored according to any suitable method known in the art. For example, product formation can be monitored by spectroscopic means, such as nuclear magnetic resonance spectroscopy (MR, e.g., ¹H or ¹³C), infrared spectroscopy (TR), spectrophotometry (e.g., in-situ FT-IR or UV-visible), mass spectrometry (MS), or by chromatography such as high pressure liquid chromatography (HPLC), gas chromatography (GC), gel-permeation chromatography (GPC), or thin layer chromatography (TLC).

In a non-limiting embodiment, block 208 includes reacting an amino or imino nitrogen of a [Ru—H(PN³P)(CO)] complex to a tetra-coordinated aluminum hydride site grafted to mesoporous silica material. The organo-ruthenium complex can be dissolved in an organic solvent before being introduced to the modified support. In some cases, block 208 can include dissolving the organo-ruthenium complex in toluene. In some cases, the reactants can remain in contact for 1-5 hours. Block 208 can further include one or more washing steps after the reaction is complete. For example, the immobilized complex can be washed 4 times in toluene and dried under vacuum.

In block 210, the method includes thermally treating the immobilized Al—N complex. Thermal treatment includes heating the immobilized catalyst at an elevated temperature under a dynamic vacuum. In some cases, block 210 can include heating the immobilized Al—N complex to stabilize the chemical bond and thereby enhance the activity of the heterogeneous catalyst. In a non-limiting example, the dried immobilized Al—N complex can be heated at about 100° C. for about 20 hours under a dynamic vacuum of 10⁻⁵ mbar.

### II. Formic Acid Decomposition

Embodiments of the present disclosure describe methods of producing hydrogen gas from the catalytic decomposition formic acid and/or formate. For example, the methods include contacting formic acid and/or formate with the heterogeneous catalyst as described above under appropriate conditions to promote dehydrogenation of formic acid. In some embodiments, contacting can result in the production of hydrogen and CO₂ gas which is substantially free of carbon monoxide (CO). As used herein, the term “substantially free” means that the component is produced or is present in an amount of less than 0.1%, less than 0.01%, less than 0.001%, or less than 0.0001% based on the weight of the produced gases or present gases.

Formic acid and/or formate decomposition can include dehydrogenation and/or dehydration. In one or more embodiments of the present disclosure, methods of generating hydrogen gas include selectively dehydrogenating formic acid and/or formate with a heterogeneous catalyst as described above. Selectively dehydrogenating refers to a reaction that is substantially free of formic acid dehydration into water and carbon monoxide. In one or more embodiments of the present disclosure, selectively dehydrogenating means the reaction produces a pure H₂ and CO₂ mixture (50:50 vol. %).

In some cases, a liquid phase that includes formic acid and/or formate contacts the heterogeneous catalyst. For example, formic acid and/or a formate salt can be mixed with water or aqueous medium to prepare an aqueous solution having an appropriate concentration of formic acid and/or formate, and then the prepared solution can contact the heterogeneous catalyst. The concentration of formic acid or formate in the solution is not limited, and can be adjusted within a range of not less than 1% by volume to less than 100% by volume. The concentration can be based on the hydrogen production efficiency of the catalyst (TOF). In some cases, the concentration of formic acid and/or formate in the solution is at least 15% by volume.

The decomposition reaction can be performed using a mixture of formic acid and formate salt as the substrate. The molecular ratio of HCOOH:HCOO⁻ can be in the range of 1:20 to 30:1, such as 1:5 to 20:1, 1:1 to 15:1, or 5:1 to 14:1 (e.g., 9:1). The reaction can be conducted at a pH in the range of 0-6, such as 1-5, 1.5-4.5, 2-4 or 2-3.5. The formate salt may be any formic salt as long as the cation does not substantially interfere with the chemical reaction. In one or more embodiments, the cation is an inorganic cation. For example, the cation can be sodium, potassium, lithium, cesium, calcium or ammonium. In some cases, a mixture of different formate salts (with different cations, for example) is used as the substrate.

The formic acid and/or formate can contact the heterogeneous catalyst in the presence of one or more additives. For example, the additive can be one or more alkaline or basic compounds. In some cases, the inclusion of an organic or inorganic base, such as an amine (e.g., triethylamine) or a metal hydroxide (e.g., KOH) can improve the conversion to hydrogen gas and CO₂. Alternatively, the substrate can be free of a base additive or all base additives. In some cases, the contacting step is free of amines or free of a trialkylamine.

The formic acid and/or formate can contact the heterogeneous catalyst in the presence of an additive, such as a decomposition reaction medium, that forms part of the liquid phase. In one more embodiments, the reaction medium includes an alcohol (e.g., methanol), water, or is a combination of water and alcohol (e.g., forming an aqueous medium). In some cases, the decomposition reaction medium is substantially free of any organic solvents. For example, the amount of organic solvent present is less than 0.1%, less than 0.01%, less than 0.001%, or less than 0.0001% based on the weight of the liquid phase. In some cases, the solvent for use in the contacting step is substantially free of dimethyl sulfoxide (DMSO), toluene, or other comparable organic solvents. In some examples, the solvent is free of organic solvents (i.e., 0% organic solvents or undetectable levels of solvent).

Alternatively, the decomposition reaction medium can include an organic solvent or mixture of solvents. Suitable solvents can be selected from petroleum ethers; acetonitrile; aromatic hydrocarbons such as benzene, toluene, xylene, and mesitylene; ketones such as acetone, and methyl ethyl ketone; ethers such as tetrahydrofuran, dioxane, bis(2-methoxyethyl)ether, diethyl ether, di-isopropyl ether, and t-butyl methyl ether; alcohols such as methanol, ethanol, butanol, and isopropyl alcohol; aliphatic hydrocarbons such as pentane, hexanes, heptane; esters such as methyl acetate, ethyl acetate, methyl formate, ethyl formate, isopropyl acetate, and butyl acetate; amides such as dimethylformamide and dimethylacetamide; sulfoxides such as dimethyl sulfoxide; halogenated aliphatic and aromatic hydrocarbons such as dichloromethane, chloroform, ethylene chloride, chlorobenzene, dichlorobenzene, and trichlorobenzene; and cyclic solvents such as cyclopentanone, cyclohexanone, and 2-methylpyrrolidone. The organic solvent can be an ionic liquid, i.e., an organic salt with a melting point below 100° C., such as ionic liquids based on anions with modest coordination ability. The solvent can include an ionic liquid selected from the group consisting of 1-ethyl-3-methylimidazolium tetrafluoroborate, 1-butyl-3-methylimidazolium chloride, 1-butyl-3-methylimidazolium chloride, 1-butyl-3-methylimidazolium hexafluorophosphate, 1-ethyl-3-methylimidazolium tetrafluoroborate, 1-butyl-3-methylimidazolium chloride, 1-butyl-3-methylimidazolium chloride, and 1-butyl-3-methylimidazolium hexafluorophosphate. In some cases, a mixture of aqueous and organic liquids can be present.

The contacting step can be conducted at a temperature in the range of ambient temperatures to about 200° C. In some cases, the temperature is less than about 200° C., less than about 150° C., less than about 100° C., or less than about 50° C. In some cases, the contacting step is conducted at a temperature within the range of about 20-100° C., such as about 90° C. or about 40° C. The temperature can be manipulated to control the rate of hydrogen gas production. The temperature can be applied from outside the reaction vessel using suitable heating/cooling equipment such as heat exchangers, electric heating, an oil or water bath. In some cases, escape of heat can be controlled with insulation surrounding the reaction vessel. Heat transfer can be controlled by mixing the formic acid and the optional formate and/or reaction medium, using an impeller system or other stirring mechanism.

The rate of hydrogen production can be controlled by manipulating the supply of formic acid and/or formate to the reaction vessel. For example, formic acid can be supplied to the reaction vessel including the heterogeneous catalyst at a feed rate of 0.1 mL to 2.2 L per minute. The reaction vessel can include an inlet for formic acid and/or formate and/or a gas outlet. The gas outlet may be provided as a valve that is configured to control the pressure inside the reaction vessel. In some cases, the contacting step can be performed at an elevated pressure. For example, the pressure can be from about 15 psi to about 500 psi (e.g., from about 25 psi to about 450 psi, from about 50 psi to about 400 psi, from about 100 psi to about 300 psi, or from about 125 psi to about 250 psi). Alternatively the contacting step can be performed at atmospheric temperature. For reactions conducted above ambient pressures, the inlet can be coupled to a pump. The reaction vessel can include probes for measuring the temperature and pressure inside the vessel, such as a thermometer and a pressure gage. The reaction vessel inlet can be connected to a reservoir containing the formic acid and/or formate. The reaction vessel outlet can direct the produced gas to a storage vessel. Alternatively, the outlet can be connected to an optional CO₂ separator and direct pure hydrogen gas to a desired application. The gas outlet can be configured to remove moisture generated in the reaction vessel. The moisture removed can be condensed (e.g., by exposure to reduced temperature) and feed into the supply of formic acid and/or formate (e.g., into the reservoir).

Catalytic decomposition of formic acid can be conducted batch-wise or continuously. In the batch-wise operation mode, the amount of formic acid and/or formate added per batch determines the amount of hydrogen gas being produced. In the continuous mode, the rate of adding formic acid and/or formate into the reaction vessel can be used to determine rate and/or amount of hydrogen being produced. A heterogeneous catalyst as described above is easily separated from the contents of the reaction vessel and reused for additional cycles or other uses.

The amount of prepared catalyst in the reaction vessel can be within the range of 0.001-1.0 mol %, or within the range of about 1-50 μmol. In some cases, the amount of homogeneous catalyst can be based upon the amount of ruthenium in the reaction. For example, the amount of ruthenium utilities in the contacting step can be about 1.5 μmol. Amounts of heterogeneous catalyst are not limited, however, and may be adjusted, in consideration of conditions such as the concentration of formic acid and/or formate or the presence of additives that may increase the reaction rate relative to the rate using the organo-ruthenium complex in its homogeneous form (i.e., unsupported or un-immobilized).

The dehydrogenation reaction of the present disclosure is robust because the heterogeneous catalyst is stable at temperatures ≥ about 60° C., such as ≥ about 80° C., ≥ greater than 120° C., ≥ about 150° C., or ≥ about 180° C. As used herein, “stable” means that the catalyst does not exhibit measurable degradation or measurable loss of activity after about 5, about 10, about 20, about 50 or about 100 catalytic cycles or at least 8 hours of continuous reaction conditions, such as about 10, 12, or 14 hours.

A heterogeneous catalyst of the present disclosure can convert formic acid (and/or formate) at an extremely high turnover frequency (TOF) under moderate conditions. For example, the TOF can be at least 30,000/hour, at least about 35,000/hour, at least about 40,000/hour, at least about 45,000/hour, at least about 47,000/hour or at least about 50,000/hour under batch conditions at a temperature of about 90° C. In some cases, a heterogeneous catalyst of the present disclosure can promote the decomposition of formic acid at a TOF within a range of about 30,000 to 100,000/hour. In some cases, the heterogeneous catalyst will exhibit an initial TOF of at least about 47,000/hour or at least about 50,000/hour and an average TOF of at least about 11,000 under continuous conditions at a temperature of about 90° C. (e.g., as measured within the first 15-60 minutes of the reaction). In some cases, the TOF can be increased by performing the reaction temperatures greater than about 90° C. or in the presence of additives as described above.

A heterogeneous catalyst of the present disclosure can generate hydrogen gas at an extremely high turnover number (TON) under moderate conditions. For example, the TON can be at least 50,000, at least about 75,000, at least about 100,000, at least about 125,000, at least about 130,000, or at least about 150,000, at a temperature of about 90° C. In some embodiments of the present disclosure, a heterogeneous catalyst generates hydrogen from formic acid with a TON within a range of about 50,000 to about 1,000,000.

The TOF and TON of a heterogeneous catalyst of the present disclosure are significantly improved relative to immobilized catalysts that have not been subjected to the thermal treatment described above. An improvement in TOF and TON demonstrate the enhanced activity and stability conferred by thermally treating the immobilized catalyst during synthesis of the heterogeneous catalyst.

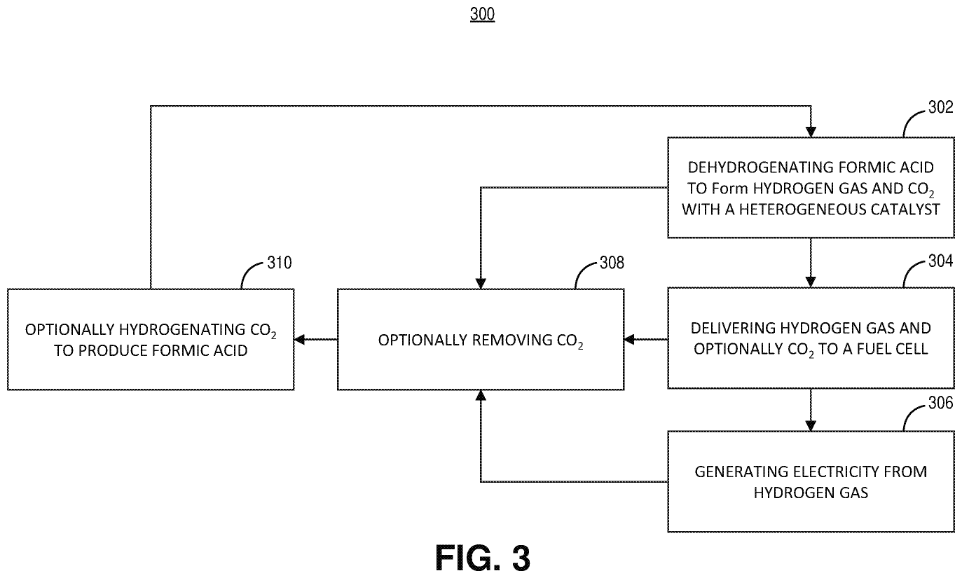

Embodiments of the present disclosure further describe a method for generating electricity. As shown in FIG. 3, method 300 describes generating electricity from hydrogen gas produced from formic acid. While this embodiment describes formic acid, the exemplified substrate can be mixed with or replaced with a liquid phase that includes formate, and one or more additives as described above. For example, the liquid phase of the reaction can include formic acid in the presence of water, organic liquid and/or an alkaline compound. Method 300 can be performed in a device or apparatus within a larger device, apparatus, or structure that will utilize the electricity generated. For example, the method can be performed on board a vehicle or within a portable electronic device, a dwelling, or an industrial plant.

In block 302, the method includes dehydrogenating formic acid with an heterogeneous catalyst as described above, to form hydrogen gas and CO₂. In a particular embodiment, the heterogeneous catalyst includes an organo-ruthenium complex of formula (I) or formula (II) immobilized to a surface of an aluminum-modified mesoporous silica material (e.g., a particle or a fibrous silica nanosphere) by a chemical bond between the amino or imino nitrogen of the organo-ruthenium complex and a tetra-coordinated aluminum grafted to the surface. The selection of a suitable heterogeneous catalyst can be based on the TOF of the catalyst and the energy demand of the end use. For example, if the end use is an electric automobile, the catalyst can be a heterogeneous catalyst of the present disclosure exhibiting a TOF of at least 47,000/hour. Block 302 may include providing a system including source of formic acid, in the optional presence of one or more additives, the heterogeneous catalyst, and a reaction vessel. Block 302 may further include delivering formic acid to the reaction vessel. Block 302 may further include adjusting the conditions in the reaction vessel to promote the conversion of formic acid to pure hydrogen gas and carbon dioxide. For example, the temperature of the reaction vessel can be controlled to be less than 100° C. In some cases, block 302 includes storing the hydrogen and/or CO₂ if the hydrogen is not used immediately. In some cases, block 302 includes performing an optional separation step to separate CO₂ from the gases produced in the reaction vessel and transferring the separated CO₂ to a storage vessel as described in block 308. Alternatively separated CO₂ can be released into the atmosphere.

In block 304, the method includes delivering the produced hydrogen gas, and optionally CO₂, to a fuel cell. Block 304 can include controlling the flow of hydrogen gas. Block 304 can include providing a fuel cell. For example, the fuel cell can be a proton exchange membrane fuel cell, an alkaline fuel cell, a sulfuric or phosphoric acid fuel cell, or a solid oxide fuel cell. The fuel cell can be a portable fuel cell, a stationary fuel cell or a fuel cell used in transport. In some cases, block 304 includes mixing the hydrogen gas with air or oxygen. In some cases, step 304 includes optionally separating CO₂ from the gases as they are delivered to the fuel cell and transferring the separated CO₂ to a storage vessel as described in block 308. Alternatively separated CO₂ can be released into the atmosphere.

In block 306, the method includes generating electricity from the hydrogen gas including oxidizing the hydrogen gas with oxygen gas in the fuel cell, thereby generating electric energy. Block 306 can include delivering air or oxygen to the fuel cell. In some cases, block 306 includes optionally separating CO₂ from the gases delivered to the fuel cell and transferring the separated CO₂ to a storage vessel as described in block 308.

Method 300 optionally includes block 310, in which the optionally separated CO₂ can be converted into formic acid by hydrogenation. Block 310 can include providing a reaction vessel including a catalyst for hydrogenating CO₂. The catalytically-produced formic acid can be a source of formic acid for additional catalytic cycles and be directed into the reaction vessel for contacting the heterogeneous catalyst as described above for block 302.

A first aspect of the present invention will now be described with reference to the following clauses of which:
Clause 1: A heterogeneous catalyst for decomposition of formic acid into hydrogen gas and CO₂ comprising an organo-ruthenium complex comprising an amino or imino group, wherein a nitrogen atom of the amino or imino group is immobilized to a tetra-coordinated aluminum atom grafted to a surface of an inorganic oxide.
Clause 2: The heterogeneous catalyst according to clause 1, wherein the heterogeneous catalyst has the formula (M-O—)₂(X)Al—[N(RR′R″)Ruₘ], wherein M is a metal of an inorganic oxide support,

X is a hydride or halide,

each R and R′ are independently selected from a hydrogen atom or a substituted or unsubstituted alkyl, heteroalkyl, cycloalkyl, heterocyclyl, aryl, and heteroaryl group;

R″ is selected from a substituted or unsubstituted alkyl, heteroalkyl, cycloalkyl, heterocyclyl, aryl, and heteroaryl group; and

m is 1 or 2.
Clause 3: The heterogeneous catalyst according to clause 2, wherein the inorganic oxide support is a porous material selected from the group consisting of silica, alumina, silica-alumina, a metallic surface, a Metal-organic framework (MOF) and a zeolite.
Clause 4: The heterogeneous catalyst according to clause 2 or clause 3, wherein the inorganic oxide support is a fibrous silica nanosphere.
Clause 5: The heterogeneous catalyst according to clause 1, wherein the organo-ruthenium complex is a ruthenium PN³ pincer-type complex having the structure of formula (I):

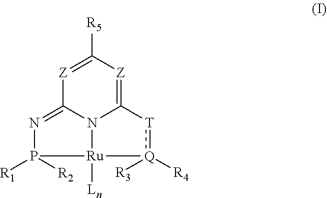

wherein: R₁ and R₂, are each independently, a substituted or unsubstituted, alkyl_{(C≤12)}, aryl_{(C≤12)}, or aralkyl_{(C≤12)} group;

R₃ and R₄, if present, are each independently, a substituted or unsubstituted, alkyl_{(C≤12)}, aryl_{(C≤12)}, or aralkyl_{(C≤12)} group;

R₅ is, a substituted or unsubstituted, alkyl_{(C≤12)}, aryl_{(C≤12)}, or aralkyl_{(C≤12)} group; each Z is independently CR₆, N or P;

R₆ is a hydrogen atom or, a substituted or unsubstituted, alkyl_{(C≤12)}, aryl_{(C≤12)}, aralkyl_{(C≤12)}, amino, hydroxyl, or alkoxyl group;

T is a N, NR₇, C, or CR₈;

R₇ and R₈ are each independently a hydrogen, or, a substituted or unsubstituted, alkyl_{(C≤12)}, aryl_{(C≤12)}, or aralkyl_{(C≤12)} group;

L is a anionic ligand or a neutral ligand and n is 0, 1, or 2;

Q is P or N; and

optionally wherein T and Q, together, form a 5 or 6 membered heterocyclic ring; wherein the heterocyclic ring can optionally be substituted with one or more heteroatoms and or one or more sites of the heterocyclic ring are substituted with one or more, substituted or unsubstituted, alkyl_{(C≤12)}, aryl_{(C≤12)}, or aralkyl_{(C≤12)} groups, and optionally wherein the heterocyclic ring can have a fused ring attached thereto, provided when T and Q form a 5 or 6 membered heterocyclic ring, one or both of R₃ and/or R₄ are not present; and

[symbol] designates a single bond or a double bond.
Clause 6: The heterogeneous catalyst according to clause 5, wherein T is NH, Q is P, R₁, R₂, R₃ and R₄ are each a t-butyl group, X is a hydrogen atom, L is carbon monoxide, and n is 1.
Clause 7: The heterogeneous catalyst according to clause 5, wherein T is CH₂ and Q is N.
Clause 8: The heterogeneous catalyst of according to clause 1, wherein the organo-ruthenium complex is a bidentate ruthenium N,N′-diimine ligand complex according to formula (II)

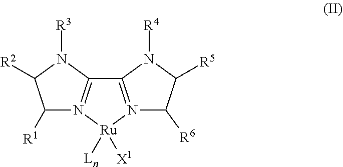

wherein: R¹, R², R³, R⁴, R⁵, and R⁶ are each independently selected from hydrogen, substituted or unsubstituted alkyl, and substituted or unsubstituted aryl;

wherein: R¹, R², R³, R⁴, R⁵, and R⁶ are each independently selected from hydrogen, substituted or unsubstituted alkyl, and substituted or unsubstituted aryl;

X¹ is a halide, a hydride, or a formate ion;

L is a neutral ligand or an anionic ligand, and n is 0, 1, or 2.
Clause 9: The heterogeneous catalyst of clause 1, clause 5, clause 6, clause 7, or clause 8, wherein the tetra-coordinated aluminum is grafted to the surface of the inorganic oxide support by a process comprising:

(a) reacting a dehydroxylated inorganic oxide support with diisobutyl aluminum hydride to form a bipodal and tetrahedral isobutyl-aluminum complex; and

(b) heating the support to form a bipodal and tetrahedral hydride-aluminum complex.

A second aspect of the present invention is described with reference to the following clauses of which:
Clause 10: A method of making a heterogeneous catalyst for decomposition of formic acid into hydrogen gas and CO₂ comprising:

providing an inorganic oxide support comprising at least one bipodal and tetrahedral aluminum atom on an accessible surface of the inorganic oxide;

immobilizing an organo-ruthenium complex comprising an accessible amino or imino nitrogen atom by forming a chemical bond between the nitrogen atom and the bipodal and tetrahedral aluminum atom; and

heating the immobilized organo-ruthenium complex at a temperature sufficient to stabilize the chemical bond.
Clause 11: The method according to clause 10, wherein providing the inorganic oxide support comprises:

grafting an aluminum alkyl precursor to a surface of a dehydroxylated inorganic oxide support to form an aluminum alkyl-modified support; and

heating the aluminum alkyl-modified support to form an accessible bipodal and tetrahedral aluminum atom.
Clause 12: The method according to clause 11, wherein the aluminum alkyl precursor is diisobutyl aluminum, diisobutyl aluminum hydride, or diisobutyl aluminum halide.
Clause 13: The method according to clause 11 or clause 12, wherein the method further comprises dehydroxylating the inorganic oxide support to achieve a surface hydroxyl density of about 0.1 to about 2 OH/nm².
Clause 14: The method according to clause 10, clause 11, clause 12, or clause 13, wherein the inorganic oxide support is a porous material selected from the group consisting of silica, alumina, silica-alumina, a metallic surface, a Metal-Organic Framework (MOF) and a zeolite.
Clause 15: The method according to one of clauses 10-14, wherein the inorganic oxide support is a fibrous silica nanosphere.
Clause 16: The method according to one of clauses 10-15, wherein the organo-ruthenium complex is a ruthenium PN³ pincer-type complex having the structure of formula (I):

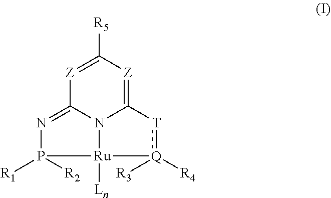

wherein: R₁ and R₂, are each independently, a substituted or unsubstituted, alkyl_{(C≤12)}, aryl_{(C≤12)}, or aralkyl_{(C≤12)} group;

R₃ and R₄, if present, are each independently, a substituted or unsubstituted, alkyl_{(C≤12)}, aryl_{(C≤12)}, or aralkyl_{(C≤2)} group;

R₅ is, a substituted or unsubstituted, alkyl_{(C≤12)}, aryl_{(C≤12)}, or aralkyl_{(C≤12)} group;

each Z is independently CR₆, N or P;

R₆ is a hydrogen atom or, a substituted or unsubstituted, alkyl_{(C≤12)}, aryl_{(C≤12)}, aralkyl_{(C≤12)}, amino, hydroxyl, or alkoxyl group;

T is a N, NR₇, C, or CR₈;

R₇ and R₈ are each independently a hydrogen, or, a substituted or unsubstituted, alkyl_{(C≤12)}, aryl_{(C≤12)}, or aralkyl_{(C≤12)} group;

L is a anionic ligand or a neutral ligand and n is 0, 1, or 2;

Q is P or N; and

optionally wherein T and Q, together, form a 5 or 6 membered heterocyclic ring; wherein the heterocyclic ring can optionally be substituted with one or more heteroatoms and or one or more sites of the heterocyclic ring are substituted with one or more, substituted or unsubstituted, alkyl_{(C≤12)}, aryl_{(C≤12)}, or aralkyl_{(C≤12)} groups, and optionally wherein the heterocyclic ring can have a fused ring attached thereto, provided when T and Q form a 5 or 6 membered heterocyclic ring, one or both of R₃ and/or R₄ are not present; and

[symbol] designates a single bond or a double bond.
Clause 17: The method according to clause 16, wherein T is NH, Q is P, R₁, R₂, R₃ and R₄ are each a t-butyl group, X is a hydrogen atom, L is carbon monoxide, and n is 1.
Clause 18: The method according to clause 16, wherein T is CH₂ and Q is N.
Clause 19: The method according to one of clauses 10-15, wherein the organo-ruthenium complex is a bidentate ruthenium N,N′-diimine ligand complex according to formula (II)

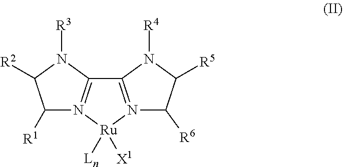

wherein: R¹, R², R³, R⁴, R⁵, and R⁶ are each independently selected from hydrogen, substituted or unsubstituted alkyl, and substituted or unsubstituted aryl;

X¹ is a halide, a hydride, or a formate ion;

L is a neutral ligand or an anionic ligand, and n is 0, 1, or 2.

A third aspect of the present invention is be described with reference to the following clauses of which:
Clause 20: A method of generating electricity comprising:

(1) contacting formic acid, formate or a mixture thereof with a heterogeneous catalyst to form hydrogen gas and CO₂, wherein the heterogeneous catalyst comprises an organo-ruthenium complex comprising an amino or imino group, wherein a nitrogen atom of the amino or imino group is immobilized to a tetra-coordinated aluminum atom grafted to a surface of an inorganic oxide;

(2) delivering the hydrogen gas to a fuel cell; and

(3) oxidizing the hydrogen gas in the fuel cell to generate electricity.
Clause 21: The method according to clause 20 wherein the heterogeneous catalyst comprises one or more of the heterogenous catalysts described in one of the clauses 2-9.

Changes and modifications, additions and deletions may be made to the structures and methods recited above and shown in the drawings without departing from the scope or spirit of the disclosure or the following claims.

The following examples are intended to illustrate the above invention and should not be construed as to narrow its scope. One skilled in the art will readily recognize that the examples suggest many other ways in which the invention could be practiced. Numerous variations and modifications may be made while remaining within the scope of the invention.

### Example

The biggest challenges of the 21st century are mainly related to energy. The use of hydrogen to generate energy has gained remarkable attention in the last decades. Hydrogen has been identified as a secure and clean energy carrier, and is expected to play a crucial role as a secondary fuel and energy carrier in the new energy system. However, the problem of storage and transportation represents a bottleneck for the materialization of the hydrogen economy. Liquid-phase chemical hydrogen storage, primarily in the form of formic acid is considered a potential alternative to the gaseous state. However, dehydrogenation of formic acid into hydrogen is required.

Several homogeneous and heterogeneous catalysts have been investigated to maximize the dehydrogenation process. The homogenous system is by far the most investigated due to the high activity and selectivity in hydrogen generation. In contrast, the reported heterogeneous systems show poor catalytic performance. Yet, the heterogeneous form is the most interesting for practical applications.

This example describes the synthesis of a heterogeneous catalyst using a mesoporous material of the KCC family of fibrous silica nanospheres: KCC-1, which is a very high surface area support (>700 m²/g). The support is modified by: (1) treating the support at an elevated temperature (about 700° C.) under vacuum or under dry flowing gas to remove absorbed water and isolate the remaining hydroxyl groups; (2) reacting the support with an aluminum alkyl compound and thermally treating the support to evolve the alkane, (3) immobilizing an organo-ruthenium complex to the support; and (4) thermally treating the immobilized catalyst at 100° C. to strongly attach the complex to the support. The heterogeneous catalyst synthesized by the methods described herein, and detailed below, promotes decomposition of formic acid at room temperature with extremely high TOF, a long lifespan, and can be recycled without leaching. These characteristics are advantageous for use in a hydrogen production system for the automotive industry.

All the synthesis experiments described below were carried out under strictly controlled atmospheres (vacuum lines and or schlenck tubes). Treatments of the surface species were carried out using high vacuum lines (1.34 Pa) and glove box techniques. The toluene was distilled on Na-benzophenone and degassed through freeze pump thaw cycles.

### 1. Dehydroxylation of KCC-1 at 700° C.

Referring to FIG. 4 (inset), KCC-1 was dehydroxylated in a quartz reactor fitting a tubular furnace under a dynamic vacuum (10⁻⁵ mbar) at 700° C. for approximately 30 h (3 h at 150° C. and 16 h at 700° C. with a rate of 60° C./h). The resulting KCC-1700 had a surface silanol concentration of 1.8 mmol/g of ≡Si—OH, obtained by titration with MeLi and GC measurements of evolved methane. KCC-1700 was stored in the glove box for further treatment.

### 2. Support Synthesis

Referring to the scheme shown in FIG. 4, generation of a well-defined single site tetrahedral isobutyl aluminum complex on the KCC-1700 surface was achieved by selective reaction of i-Bu2Al (DIBAL) with surface ≡Si—OH groups followed by the addition of dry pentane. Grafting of DIBAL on the dehydroxylated silica surface generated [(≡Si—O—Si≡)(≡Si—O)₂ Al-iBu] sites, and also a mixture of [≡Si—H] (80%) and [≡Si-iBu] (20%) sites.

The resulting white powder was washed with dry pentane (2×) to remove unreacted DIBAL. The solid was dried under vacuum (10 mbar). The dried solid was introduced into a glass reactor and heated to 400° C. (8° C./h) for hour under dynamic vacuum (10 mbar). The thermal treatment of the isobutyl moiety via β-H elimination resulted in formation of silica supported tetrahedral aluminum hydride [Al—H] complex (1) with the evolution of isobutene. The [≡Si—H] and [≡Si-iBu] sites were unchanged. The unique and strong Lewis acid center of the formed Al—H surface was determined by measuring the adsorption/desorption of pyridine (pK_{b}=5.21) characterized by IR spectroscopy and by ¹⁵N solid state NMR.

### 3. The Catalyst Synthesis

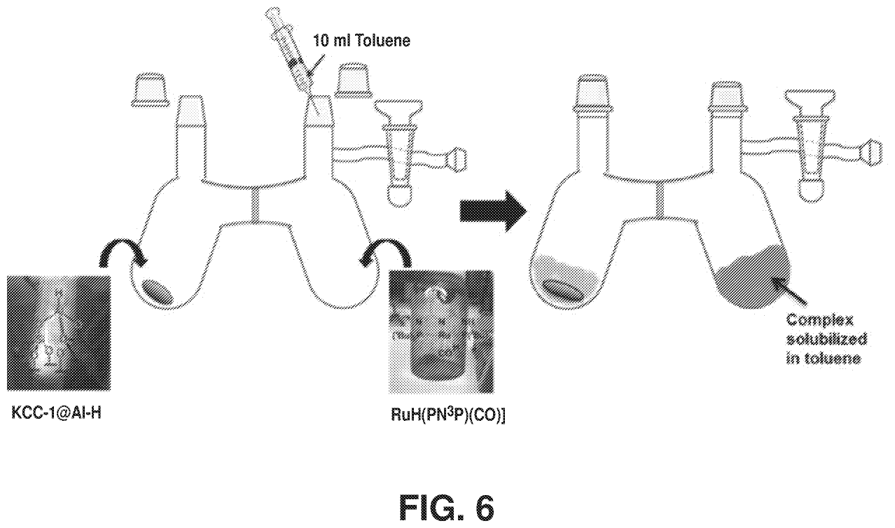

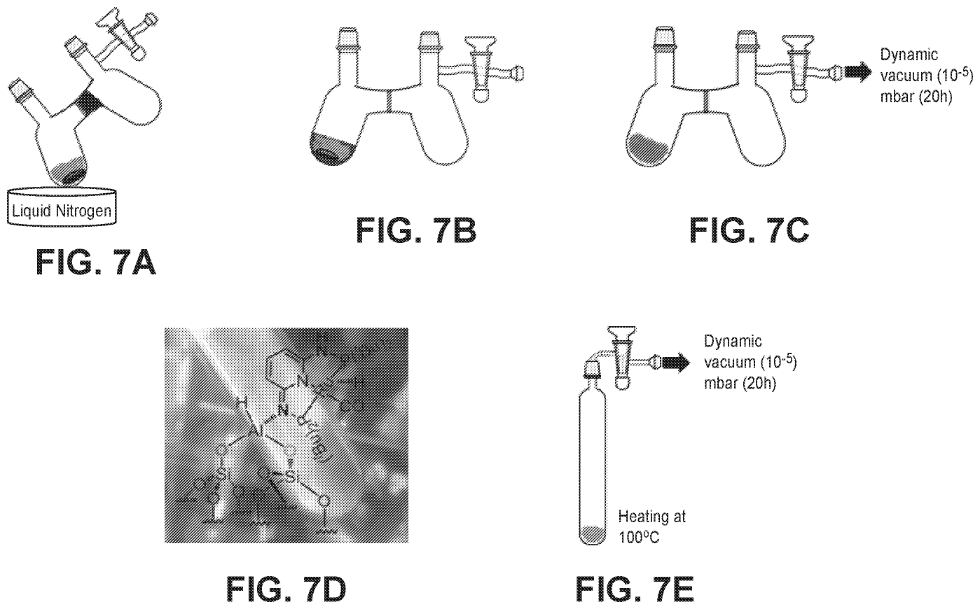

Referring to the scheme shown in FIG. 5, the synthesis of a heterogeneous [Ru—H(PN³P)(CO)]-based catalyst included reacting toluene solubilized phosphorus-nitrogen PN³P-pincer ruthenium complex [Ru—H(PN³P)(CO)] and silica supported tetrahedral aluminum hydride [Al—H] complex (1) while stirring at room temperature (20° C.) for 5 hours to yield complex (2). Complex (2) was heated (100° C.) under dynamic vacuum to yield complex (3). As shown in FIG. 6, in step one of the catalyst synthesis, the silica supported tetrahedral aluminum hydride [Al—H] complex (1) “KCC-1 @AL-H” (1 g) was introduced to one side of a double Schlenk. The ruthenium complex [Ru—H(PN³P)(CO)] (50 mg) was introduced to the other side and solubilized in 10 ml of dry and degassed toluene, forming an orange solution. Referring now to FIGS. 7(A-E), in the step two of the catalyst synthesis, the liquid phase is transferred to the support side of the Schlenk in liquid nitrogen (A). In step three, the mixture is left under stirring for 5 h. In step four (B), the catalyst obtained was washed out four times using toluene in the glovebox. In step five (C), the obtained catalyst was left under dynamic vacuum (10⁻⁵ mbar) for drying (20 h) to remove remaining toluene. In step six (D), the light yellow powder (complex (2)) obtained was stored in the glovebox. In step seven (E), the dried immobilized [Ru—H(PN³P)(CO)] catalyst (complex (2)) was heated at 100° C. under (10⁻⁵ mbar) for 20 h to produce complex (3).

### 3. Characterization of Catalysts (2) and (3)

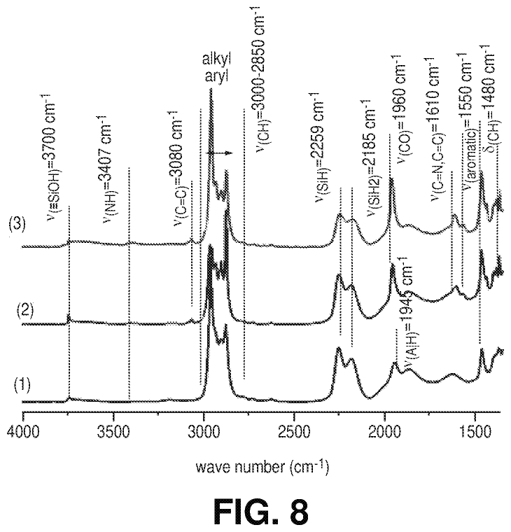

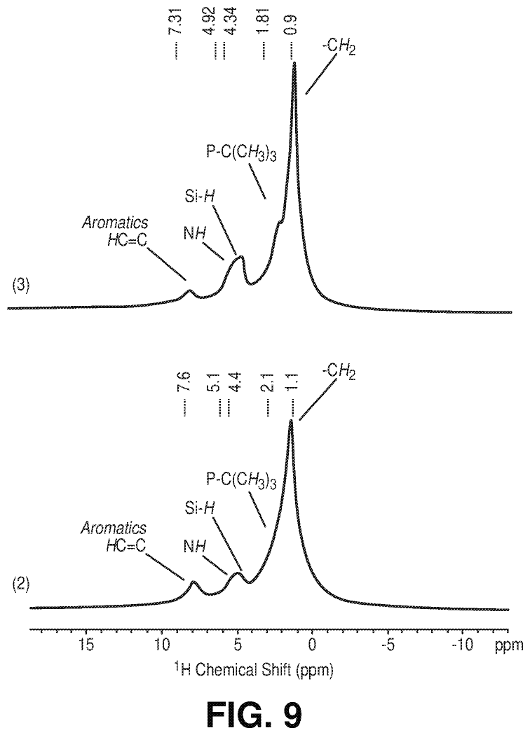

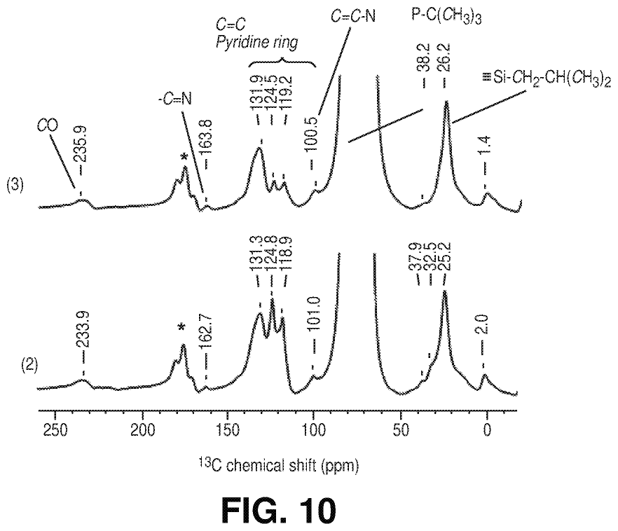

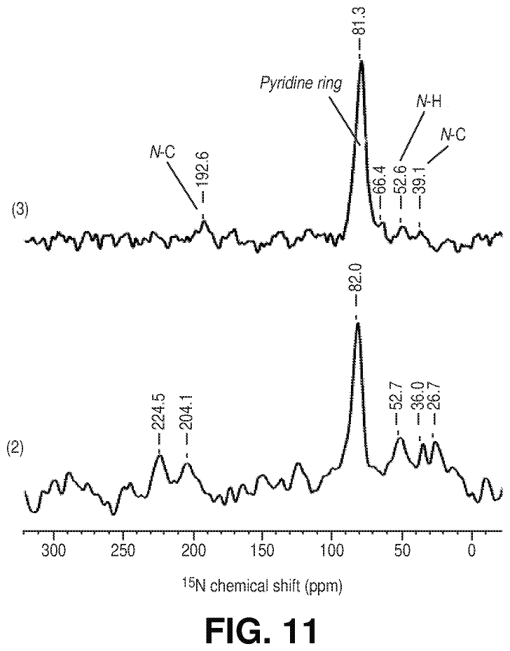

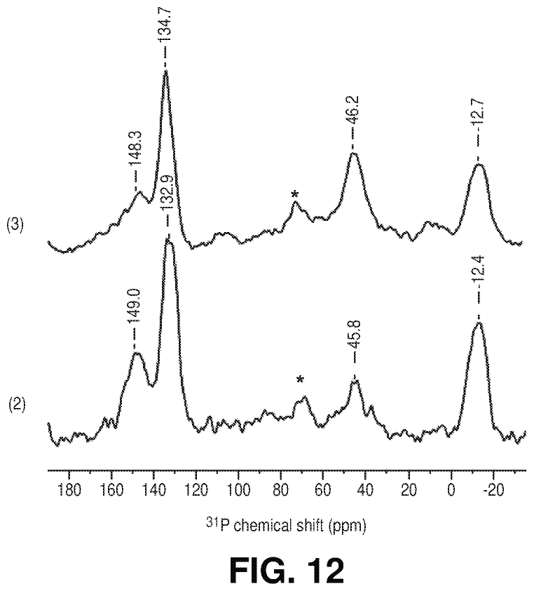

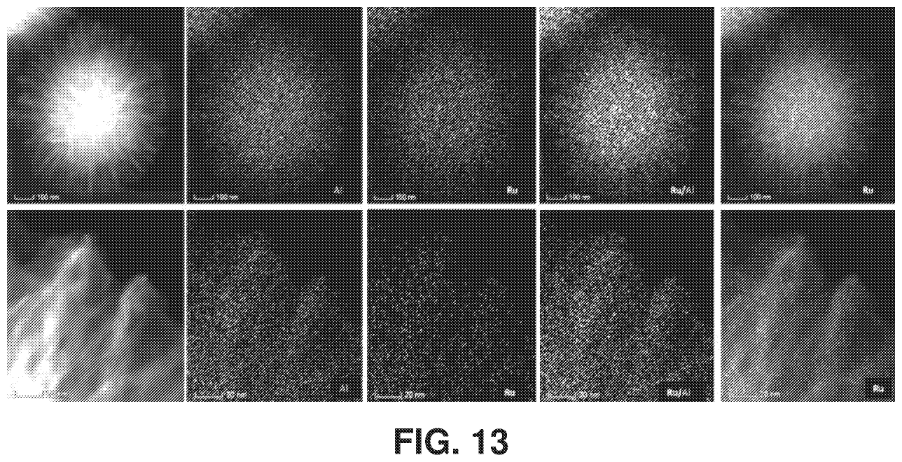

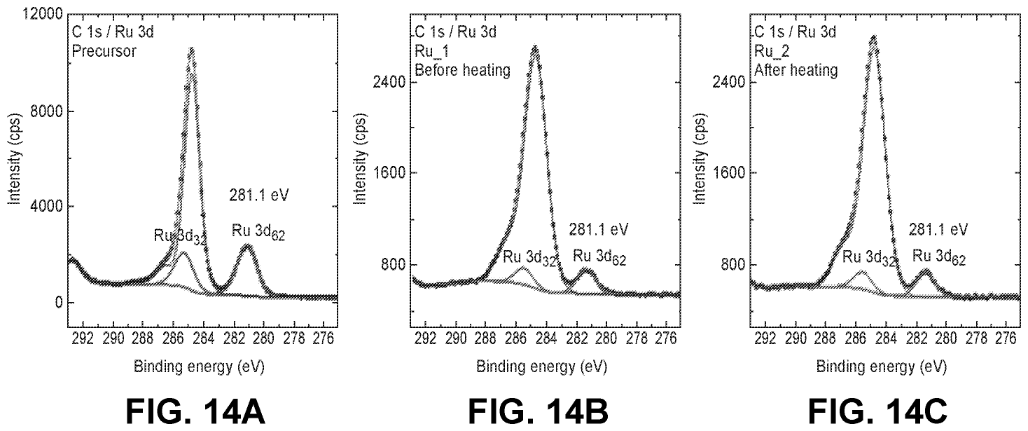

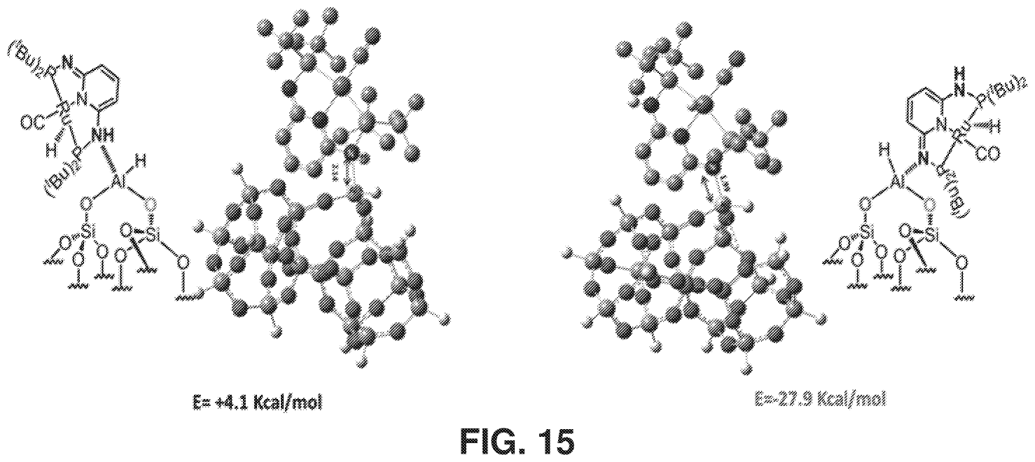

The resulting catalysts were characterized by advanced solid-state characterization techniques (FT-IR (FIG. 8), solid-state NMR: ¹H (FIG. 9), ¹³C (FIG. 10), ¹⁵N (FIG. 11), and ³¹P (FIG. 12), DNP-SENS and EF-TEM (FIG. 13), elemental analysis (Table 1 below), and X-Ray Photoelectron spectroscopy (FIGS. 14A-C). Together with DFT calculations showing a stable final structure with an E of (−27.9) Kcal/mol, the coordination was mainly assigned to the Al—N lewis acid-base interaction (FIG. 15).

a. Elemental Analysis

Elemental analyses were performed at the KAUST Analytical Core lab. Analysis of Ru was performed using a Varian, Inc. (AGILENT) 720-ES Inductively Coupled Plasma-Optical Emission Spectrometer (ICP-OES) after the samples preparation by microwave digestions on a Milestone, Inc. ETHOS 1. Analysis of C and H were performed on Flash 2000 Elemental Analyzer from Thermo Scientific. Results are presented in Table 1, with expected results provided in the parentheses.

TABLE 1

| | Ru % | C % | N % | Ratio C/Ru | Ratio N/Ru |
|---|---|---|---|---|---|
| | (mmol/g) | (mmol/g) | (mmol/g) | (theo.) | (theo.) |
| (2) | 0.68 | 6.32% | 0.26% | 24 | 2.76 |
| | (0.067) | (4.86) | (0.185) | (22) | (3) |

b. Transmission Electron Microscopy

For a better understanding of the Ru metal distribution inside the KCC-1 fibers, we performed transmission electron microscopy (TEM) analyses (FIG. 13). Moreover, a double-aberration corrected TEM of model Titan ThemisZ from Thermo Fisher Scientific was employed to complete the mentioned analysis.

Elemental distributions of Ru and Al for the catalyst (2) were determined by using the STEM-EDS spectrum imaging technique. These elemental maps contain a high degree of confidence regarding revealing the presence of Ru and Al as these are generated by acquiring the EDS signal with a high solid-angle EDS detector of model SuperX (ESI). The EF-TEM images (FIG. 13) obtained suggest that Al and Ru metals are well distributed inside the KCC-1 fibers and that the ratio of Ru/Al is, indeed, small, which correlates with the collected elemental analysis.

c. Formic Acid Dehydrogenation:
i. Catalytic Test

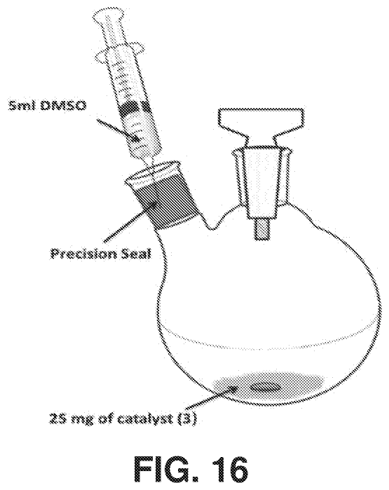

Formic acid decomposition experiments were carried out in a two-necked round flask (FIG. 16), by introducing 25 mg of catalyst (3) or (2) (1.5 μmol of Ru) inside the glove box. DMSO (5 ml) was added via syringe to the flask containing the catalyst and a magnetic stir bar. The system was then connected with a reflux condenser and stirred at a temperature of 90° C. Formic acid (1.2 ml) was added with triethylamine (1.5 ml). The calculation of the volume of gas collected was based on water displacement. As described above “catalyst (2)” refers to the immobilized complex before thermal treatment, whereas “catalyst (3)” refers to the immobilized complex after the thermal treatment of step seven.

ii. Results

Decomposition of formic acid proceeds according to the scheme below:

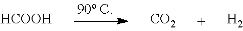

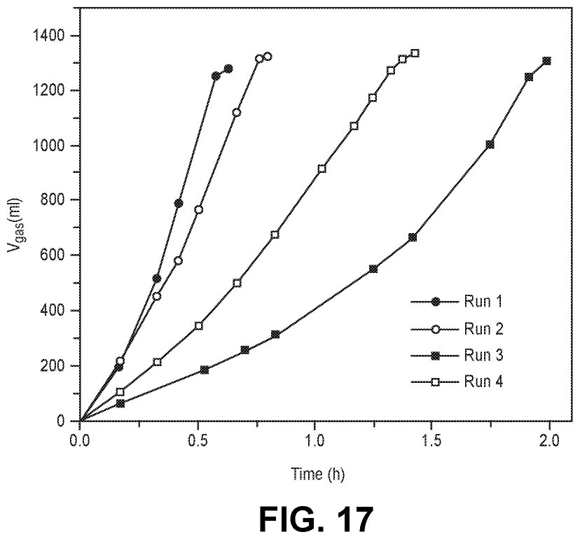

The results of four catalytic runs of formic acid decomposition with catalyst (2) is shown in FIG. 17 and Table 2.

TABLE 2

| | Run 1 | Run 2 | Run 3 | Run 4 |
|---|---|---|---|---|
| TOF (h⁻¹) | 36675 | 25574 | 18022 | 15319 |
| Conversion (%) | 95 | 99 | 97 | 99 |

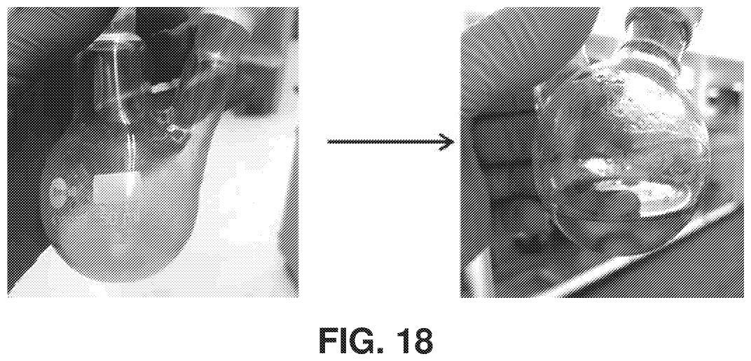

Relative to the homogeneous catalyst (i.e., the un-immobilized [Ru—H(PN³P)(CO)] catalyst) the catalytic performance of complex (2) was very high, however the catalyst leached into the liquid medium after four catalytic runs, as evidenced by the generation of a colored (brown-orange) solution (FIG. 18).

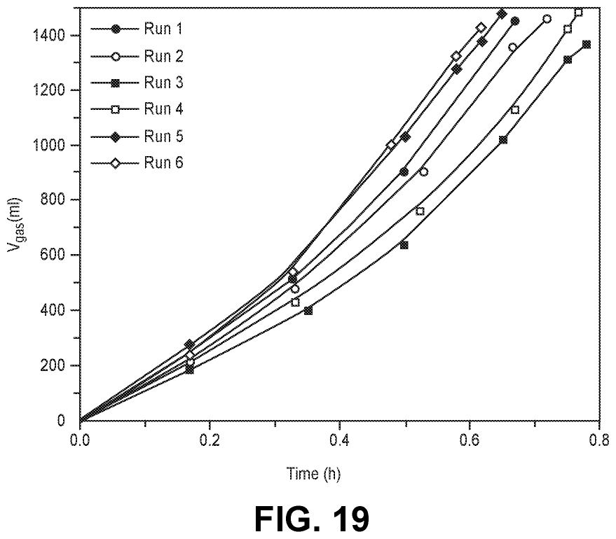

The results of six cycles of formic acid decomposition with catalyst (3) is shown in FIG. 19 and Table 3.

TABLE 3

| | Cycle 1 | Cycle 2 | Cycle 3 | Cycle 4 | Cycle 5 | Cycle 6 |
|---|---|---|---|---|---|---|
| TOF (h⁻¹) | 35475 | 35244 | 32246 | 39748 | 36550 | 35636 |
| Conversion(%) | 100 | 100 | 94 | 100 | 100 | 98 |

Comparison of the batch condition results with catalyst (2) and catalyst (3) show that thermal treatment as described in step seven increases catalytic activity, catalyst stability and prevents observable leaching even after catalyst deactivation.

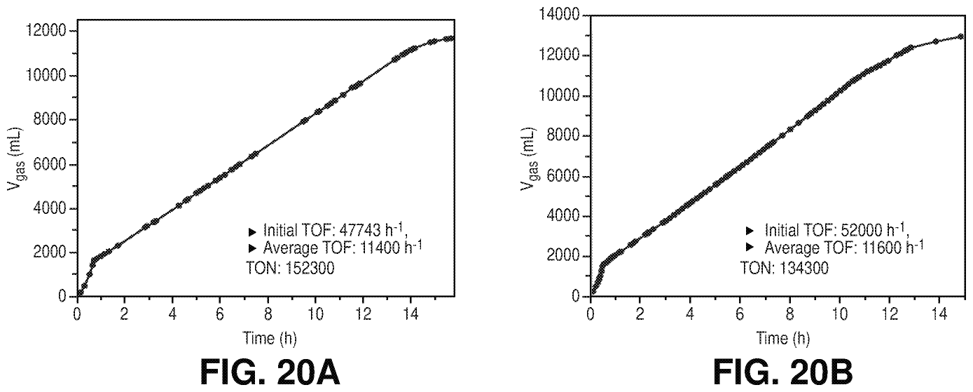

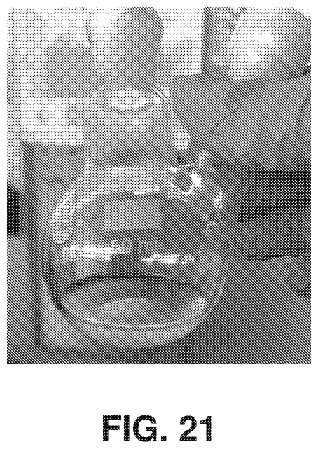

The catalytic activity of catalyst (3) under continuous conditions was also measured (FIG. 20A). The result was reproducible (FIG. 20B) and no leaching of the complex was observed in the liquid medium (FIG. 21).

Other embodiments of the present disclosure are possible. Although the description above contains much specificity, these should not be construed as limiting the scope of the disclosure, but as merely providing illustrations of some of the presently preferred embodiments of this disclosure. It is also contemplated that various combinations or sub-combinations of the specific features and aspects of the embodiments may be made and still fall within the scope of this disclosure. It should be understood that various features and aspects of the disclosed embodiments can be combined with or substituted for one another in order to form various embodiments. Thus, it is intended that the scope of at least some of the present disclosure should not be limited by the particular disclosed embodiments described above.

Thus the scope of this disclosure should be determined by the appended claims and their legal equivalents. Therefore, it will be appreciated that the scope of the present disclosure fully encompasses other embodiments which may become obvious to those skilled in the art, and that the scope of the present disclosure is accordingly to be limited by nothing other than the appended claims, in which reference to an element in the singular is not intended to mean “one and only one” unless explicitly so stated, but rather “one or more.” All structural, chemical, and functional equivalents to the elements of the above-described preferred embodiment that are known to those of ordinary skill in the art are expressly incorporated herein by reference and are intended to be encompassed by the present claims. Moreover, it is not necessary for a device or method to address each and every problem sought to be solved by the present disclosure, for it to be encompassed by the present claims. Furthermore, no element, component, or method step in the present disclosure is intended to be dedicated to the public regardless of whether the element, component, or method step is explicitly recited in the claims.

The foregoing description of various preferred embodiments of the disclosure have been presented for purposes of illustration and description. It is not intended to be exhaustive or to limit the disclosure to the precise embodiments, and obviously many modifications and variations are possible in light of the above teaching. The example embodiments, as described above, were chosen and described in order to best explain the principles of the disclosure and its practical application to thereby enable others skilled in the art to best utilize the disclosure in various embodiments and with various modifications as are suited to the particular use contemplated. It is intended that the scope of the disclosure be defined by the claims appended hereto

Various examples have been described. These and other examples are within the scope of the following claims.

1. A heterogeneous catalyst for decomposition of formic acid into hydrogen gas and CO₂ comprising an organo-ruthenium complex comprising an amino or imino group, wherein a nitrogen atom of the amino or imino group is immobilized to a tetra-coordinated aluminum atom grafted to a surface of an inorganic oxide.

2. The heterogeneous catalyst of claim 1, wherein the heterogeneous catalyst has the formula (M-O—)₂(X)Al—[N(RR′R″)Ruₘ], wherein M is a metal of an inorganic oxide support,
X is a hydride or halide,
each R and R′ are independently selected from a hydrogen atom or a substituted or unsubstituted alkyl, heteroalkyl, cycloalkyl, heterocyclyl, aryl, and heteroaryl group;
R″ is selected from a substituted or unsubstituted alkyl, heteroalkyl, cycloalkyl, heterocyclyl, aryl, and heteroaryl group; and
m is 1 or 2.

3. The heterogeneous catalyst of claim 2, wherein the inorganic oxide support is a porous material selected from the group consisting of silica, alumina, silica-alumina, a metallic surface, a Metal-organic framework (MOF) and a zeolite.

4. The heterogeneous catalyst of claim 2, wherein the inorganic oxide support is a fibrous silica nanosphere.

5. The heterogeneous catalyst of claim 1, wherein the organo-ruthenium complex is a ruthenium PN³ pincer-type complex having the structure of formula (I): 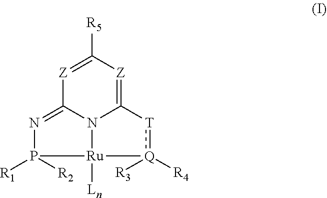
wherein: R₁ and R₂, are each independently, a substituted or unsubstituted, alkyl_{(C≤12)}, aryl_{(C≤12)}, or aralkyl_{(C≤12)} group;
R₃ and R₄, if present, are each independently, a substituted or unsubstituted, alkyl_{(C≤12)}, aryl_{(C≤12)}, or aralkyl_{(C≤12)} group;
R₅ is, a substituted or unsubstituted, alkyl_{(C≤12)}, aryl_{(C≤12)}, or aralkyl_{(C≤12)} group;
each Z is independently CR₆, N or P;
R₆ is a hydrogen atom or, a substituted or unsubstituted, alkyl_{(C≤12)}, aryl_{(C≤12)}, aralkyl_{(C≤12)}, amino, hydroxyl, or alkoxyl group;
T is a N, NR₇, C, or CR₈;
R₇ and R₈ are each independently a hydrogen, or, a substituted or unsubstituted, alkyl_{(C≤12)}, aryl_{(C≤12)}, or aralkyl_{(C≤12)} group;
L is a anionic ligand or a neutral ligand and n is 0, 1, or 2;
Q is P or N; and
optionally wherein T and Q, together, form a 5 or 6 membered heterocyclic ring;
wherein the heterocyclic ring can optionally be substituted with one or more heteroatoms and or one or more sites of the heterocyclic ring are substituted with one or more, substituted or unsubstituted, alkyl_{(C≤12)}, aryl_{(C≤12)}, or aralkyl_{(C≤12)} groups, and optionally wherein the heterocyclic ring can have a fused ring attached thereto, provided when T and Q form a 5 or 6 membered heterocyclic ring, one or both of R₃ and/or R₄ are not present; and [symbol]
designates a single bond or a double bond.

6. The heterogeneous catalyst of claim 5, wherein T is NH, Q is P, R₁, R₂, R₃ and R₄ are each a t-butyl group, X is a hydrogen atom, L is carbon monoxide, and n is 1.

7. The heterogeneous catalyst of claim 5, wherein T is CH₂ and Q is N.

8. The heterogeneous catalyst of claim 1, wherein the organo-ruthenium complex is a bidentate ruthenium N,N′-diimine ligand complex according to formula (II) 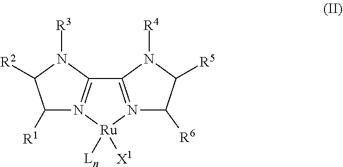
wherein: R¹, R², R³, R⁴, R⁵, and R⁶ are each independently selected from hydrogen, substituted or unsubstituted alkyl, and substituted or unsubstituted aryl;
X¹ is a halide, a hydride, or a formate ion;
L is a neutral ligand or an anionic ligand, and n is 0, 1, or 2.

9. The heterogeneous catalyst of claim 1, wherein the tetra-coordinated aluminum is grafted to the surface of the inorganic oxide by a process comprising:
(a) reacting a dehydroxylated inorganic oxide support with diisobutyl aluminum hydride to form a bipodal and tetrahedral isobutyl-aluminum complex; and
(b) heating the support to form a bipodal and tetrahedral hydride-aluminum complex.

10. A method of making a heterogeneous catalyst for decomposition of formic acid into hydrogen gas and CO₂ comprising:
providing an inorganic oxide support comprising at least one bipodal and tetrahedral aluminum atom on an accessible surface of the inorganic oxide;
immobilizing an organo-ruthenium complex comprising an accessible amino or imino nitrogen atom by forming a chemical bond between the nitrogen atom and the bipodal and tetrahedral aluminum atom; and
heating the immobilized organo-ruthenium complex at a temperature sufficient to stabilize the chemical bond.

11. The method of claim 10, wherein providing the inorganic oxide support comprises:
grafting an aluminum alkyl precursor to a surface of a dehydroxylated inorganic oxide support to form an aluminum alkyl-modified support; and
heating the aluminum alkyl-modified support to form an accessible bipodal and tetrahedral aluminum atom.

12. The method of claim 11, wherein the aluminum alkyl precursor is diisobutyl aluminum, diisobutyl aluminum hydride, or diisobutyl aluminum halide.

13. The method of claim 11, wherein the method further comprises dehydroxylating the inorganic oxide support to achieve a surface hydroxyl density of about 0.1 to about 2 OH/nm².

14. The method of claim 10, wherein the inorganic oxide support is a porous material selected from the group consisting of silica, alumina, silica-alumina, a metallic surface, a Metal-Organic Framework (MOF) and a zeolite.

15. The method of claim 10, wherein the inorganic oxide support is a fibrous silica nanosphere.

16. The method of claim 10, wherein the organo-ruthenium complex is a ruthenium PN³ pincer-type complex having the structure of formula (I): 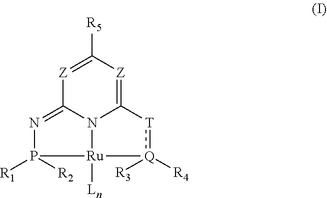
wherein: R₁ and R₂, are each independently, a substituted or unsubstituted, alkyl_{(C≤12)}, aryl_{(C≤12)}, or aralkyl_{(C≤12)} group;
R₃ and R₄, if present, are each independently, a substituted or unsubstituted, alkyl_{(C≤12)}, aryl_{(C≤12)}, or aralkyl_{(C≤12)} group;
R₅ is, a substituted or unsubstituted, alkyl_{(C≤12)}, aryl_{(C≤12)}, or aralkyl_{(C≤12)} group;
each Z is independently CR₆, N or P;
R₆ is a hydrogen atom or, a substituted or unsubstituted, alkyl_{(C≤12)}, aryl_{(C≤12)}, aralkyl_{(C≤12)}, amino, hydroxyl, or alkoxyl group;
T is a N, NR₇, C, or CR₈;
R₇ and R₈ are each independently a hydrogen, or, a substituted or unsubstituted, alkyl_{(C≤12)}, aryl_{(C≤12)}, or aralkyl_{(C≤12)} group;
L is a anionic ligand or a neutral ligand and n is 0, 1, or 2;
Q is P or N; and
optionally wherein T and Q, together, form a 5 or 6 membered heterocyclic ring;
wherein the heterocyclic ring can optionally be substituted with one or more heteroatoms and or one or more sites of the heterocyclic ring are substituted with one or more, substituted or unsubstituted, alkyl_{(C≤12)}, aryl_{(C≤12)}, or aralkyl_{(C≤12)} groups, and optionally wherein the heterocyclic ring can have a fused ring attached thereto, provided when T and Q form a 5 or 6 membered heterocyclic ring, one or both of R₃ and/or R₄ are not present; and [symbol]
designates a single bond or a double bond.

17. The method of claim 16, wherein T is NH, Q is P, R₁, R₂, R₃ and R₄ are each a t-butyl group, X is a hydrogen atom, L is carbon monoxide, and n is 1.

18. The method of claim 16, wherein T is CH₂ and Q is N.

19. The method of claim 10, wherein the organo-ruthenium complex is a bidentate ruthenium N,N′-diimine ligand complex according to formula (II) 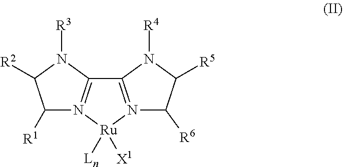
wherein: R¹, R², R³, R⁴, R⁵, and R⁶ are each independently selected from hydrogen, substituted or unsubstituted alkyl, and substituted or unsubstituted aryl;
X¹ is a halide, a hydride, or a formate ion;
L is a neutral ligand or an anionic ligand, and n is 0, 1, or 2.

20. A method of generating electricity comprising:
(1) contacting formic acid, formate or a mixture thereof with a heterogeneous catalyst to form hydrogen gas and CO₂, wherein the heterogeneous catalyst comprises an organo-ruthenium complex comprising an amino or imino group, wherein a nitrogen atom of the amino or imino group is immobilized to a tetra-coordinated aluminum atom grafted to a surface of an inorganic oxide;
(2) delivering the hydrogen gas to a fuel cell; and
(3) oxidizing the hydrogen gas in the fuel cell to generate electricity.
